(19) United States
(12) Patent Application Publication
(10) Pub. No.: US 2026/0341688 A1
(43) Pub. Date: Oct. 29, 2026

(54) DURABLE AND EFFICIENT ANODE MATERIAL DESIGN FOR METAL-AIR BATTERIES

(71) Applicant: Ore Energy B.V., Amsterdam (NL)

(72) Inventors: Aytac YILMAZ, Delft (NL); Yaiza GONZALEZ-GARCIA, Delft (NL); Jilt SIETSMA, Delft (NL)

(73) Assignee: Ore Energy B.V., Amsterdam (NL)

(21) Appl. No.: 19/487,806

(22) PCT Filed: May 30, 2024
(86) PCT No.: PCT/NL2024/050274

§ 371 Date: Nov. 25, 2025

(30) Foreign Application Priority Data
Jun. 2, 2023 (NL) 2034979

(51) Int. Cl. H01M 4/38; C21D 1/18; C21D 1/26; C22C 38/00; C22C 38/02; C22C 38/04; C22C 38/06; C22C 38/10; C22C 38/16; C25B 11/046; H01M 4/02; H01M 4/04; H01M 4/134; H01M 4/1395; H01M 4/62

(52) U.S. Cl. CPC H01M 4/38; C21D 1/18; C21D 1/26; C22C 38/001; C22C 38/002; C22C 38/008; C22C 38/02; C22C 38/04; C22C 38/06; C22C 38/10; C22C 38/16; C25B 11/046; H01M 4/0471; H01M 4/134; H01M 4/1395; H01M 4/622; C21D 2211/002; C21D 2211/005; C21D 2211/008; C21D 2211/009; H01M 2004/027

(57) ABSTRACT

The invention provides an electrode comprising an iron comprising material composition, wherein the iron comprising material composition comprises two or more metallurgical phases selected from the group consisting of: martensite, pearlite, bainite, and ferrite, wherein the iron comprising material composition (2000) comprises (i) 2-97.9 vol. % of one or more of martensite, pearlite, and bainite, (ii) 2-85 vol. % ferrite, and (iii) 0.1-10 vol. % austenite; wherein the iron comprising material composition comprises grains, wherein the grains have a number averaged equivalent circular grain diameter D, wherein the number averaged equivalent circular grain diameter D is defined by grain boundaries, wherein the number averaged equivalent circular grain diameter D is selected from the range of 1-100 μm.

### FIELD OF THE INVENTION

The invention relates to an electrode comprising an iron comprising material composition and a method for producing the electrode. The invention further relates to an iron comprising material composition and a method for producing the iron comprising material composition. The invention also relates to a device comprising the electrode comprising the iron comprising material composition.

### BACKGROUND OF THE INVENTION

Iron comprising electrodes are known in the art. US2021277527A1, for instance, relates to an electrochemical device comprising: an electrolyte; a cathode contacting the electrolyte; and an oxygen evolution reaction (OER) electrode operating as an anode, the OER electrode contacting the electrolyte, the OER electrode comprising: an iron-containing substrate; and a metal-containing layer that includes a component selecting from the group consisting of a metal ferrite, magnetite, alpha nickel hydroxide, and combinations thereof disposed over the iron-containing substrate, the metal ferrite including a metal and iron, the metal being selected from the group consisting of nickel, cobalt, manganese, and combinations thereof.

JP2005332716A describes an alkaline battery which has a positive electrode can 4, a negative electrode can 5, and a negative electrode agent 3 containing zinc or zinc alloy containing no mercury, and in which the negative electrode can 5 contacts with the negative electrode agent 3. A zinc layer 7 which contains at least one kind of elements selected from indium and bismuth in the range 0.01 wt % or more and 30 wt % or less is formed on the surface of the negative electrode can 5 in contact with the negative electrode agent 3, and the positive electrode can 4 is formed of stainless steel of austenite-ferrite two-phase system.

U.S. Pat. No. 3,700,851A describes a welding electrode for electric arc welding intended for joint welding and built-up welding stainless steels, particularly steels with a ferrite-martensitic, ferrite-martensite-austenitic or martensite-austenitic structure, and is characterized in that the electrode in the shape of a bare wire or a wire with a coating deposits a weld metal whose alloying constituents affecting the structure lie within the following analysis limits: 0.01-0.05 percent carbon, 0.1-0.9 percent silicon, 0.5-4.5 percent manganese, 15.0-18.0 percent chromium, 4.5-7.5 percent nickel, 0.2-2.5 percent molybdenum, 0.02-0.12 percent nitrogen and 0.2-3.5 percent tungsten, the remainder iron apart from the unavoidable impurities.

Abbireddy et. al. (2009): “A review of modern particle sizing methods”, Proceedings of the Institution of Civil Engineers, 162, nr. 4, p. 193-201, describes available methods of determining particle-size distribution.

### SUMMARY OF THE INVENTION

The world energy demand is increasing drastically. Sustainable energy solutions are becoming more widely employed to provide for the energy demand. However, renewable energy sources are intermittent, bringing about a need for large-scale energy storage systems. In view of cost, safety, environmental friendliness and efficiency, promising candidates for such large-scale energy storage systems may be rechargeable batteries.

Rechargeable batteries using iron electrodes are known in the state-of-the-art. The charging process of such batteries revolves around the main reaction of the reduction of ferrous ions (Fe²⁺) to metallic iron (Fe⁰). Conversely, the discharging process revolves around the oxidation of metallic iron to ferrous ions. These charging and discharging processes (of an iron electrode under alkaline conditions) are illustrated by Eq. 1:

$$\begin{matrix}{Fe ( OH )}_{2} + 2 {e}^{-} \to Fe + 2 {OH}^{-} & {E}^{0} = - 0.88 V\end{matrix} \qquad ( 1 )$$

However, a well-known side effect during charging of an iron electrode (especially under alkaline conditions) is water decomposition, yielding hydrogen. Specifically, the reaction potential of the iron anode during charging may be more negative than that of the hydrogen evolution reaction (HER), allowing the occurrence of HER. The HER side reaction is illustrated by Eq. 2:

$$\begin{matrix}2 {H}_{2} O + 2 {e}^{-} ↔ {H}_{2} + 2 {OH}^{-} & {E}^{0} = - 0.83 V\end{matrix} \qquad ( 2 )$$

The above-described reaction requires energy, and hence part of the energy that was originally intended to be stored in the battery, is wasted in the evolution of hydrogen. In other words, the hydrogen evolution reaction is a parasitic reaction that can significantly reduce the coulombic efficiency of the anode, accounting for a drastic reduction in the overall performance of the battery. Additionally, the HER causes continuous electrolyte consumption, which may limit the application and lifetime of batteries.

Another challenge for the anode part of (metal-air) batteries lies in controlling the reversibility of oxidation and reduction processes. The battery system works on the basis of reduction and oxidation of iron or any other metal which has relatively low nobility. Stable (hydr)oxide formation (such as Fe₂O₃, Fe₃O₄, and FeOOH) limits the irreversibility of oxidation and reduction processes. Therefore, the stable (hydr)oxide formation limits the accessibility to active metal and therefore shortens the lifetime of the anode.

Hence, these described issues significantly limit the lifetime and the efficiency of the (iron) anode and therefore the entire battery system. Therefore, irreversible oxidation and hydrogen evolution reactions have been the main issues in making the metal-air batteries commercially available since its discovery.

Current solutions include various additives (mostly (soluble) metal sulfides and oxides), which are incorporated in both anode and electrolyte to control the hydrogen evolution reaction. Hence, existing electrodes for (metal-air) batteries make use of adding additives (such as metal sulfides (e.g. bismuth sulfide, copper sulfide, zinc sulfide, iron sulfide etc.) in the iron anode. Such additives can increase the overpotential of the HER, which may result in suppression of the HER by affecting the kinetics of HER during charging, and retarding iron anode passivation during discharging. However, such additives can provide a solution for only a certain amount of time due to additive degradation. Furthermore, toxicity of some of the additives used for suppressing the HER provides additional drawbacks for this solution.

The prior art may further describe modification of the electrolyte in batteries with lithium hydroxides, organosulfur compounds, and sulfides. The former is employed to increase the reversibility of oxidation and reduction processes and the latter is to suppress HER. However, such solutions may not enhance the long-term stable performance of (alkaline) batteries as oxidation of the sulfides may occur at the cathode side.

The prior art may further describe fabrication of iron-metal based nanocomposites. Through nano architectural design of the electrode materials, the electrochemical performance of the iron anode may be enhanced. Such enhancement is the result of an increase in a density of interaction sites and a decrease in ion-diffusion path length. However, during the discharge/charge cycling process of a battery, the iron nanoparticles may coarsen and aggregate, leading to a decay in overall capacity. Furthermore, the synthesis of iron nanocomposites still presents issues with cost and scalability.

Hence, it appears desirable to develop a solution for suppressing HER on the (iron) electrode in order to optimize the electrochemical performance, lifetime, and practicability of (alkaline) batteries.

Hence, it is an aspect of the invention to provide an alternative iron comprising material composition for electrodes, which preferably further at least partly obviates one or more of above-described drawbacks. The present invention may have as object to overcome or ameliorate at least one of the disadvantages of the prior art, or to provide a useful alternative.

According to a first aspect, the invention provides an electrode. Especially, the invention provides an electrode comprising an iron comprising material composition. In embodiments, the iron comprising material composition may comprise two or more metallurgical phases. Especially, in embodiments, the two or more metallurgical phases may be selected from the group consisting of: martensite, pearlite, bainite, and ferrite. Further, in embodiments, the iron comprising material composition may comprise grains. The grains may, in embodiments, have a number averaged equivalent circular grain diameter D. Especially, the number averaged equivalent circular grain diameter D may be defined by grain boundaries. More especially, in embodiments, number averaged equivalent circular grain diameter D may be selected from the range of 1-100 μm. Hence, in embodiments, the invention provides an electrode comprising an iron comprising material composition, wherein the iron comprising material composition comprises two or more metallurgical phases selected from the group consisting of: martensite, pearlite, bainite, and ferrite; wherein the iron comprising material composition comprises grains, wherein the grains have a number averaged equivalent circular grain diameter D, wherein the number averaged equivalent circular grain diameter D is defined by grain boundaries, wherein the number averaged equivalent circular grain diameter D is selected from the range of 1-100 μm.

A benefit of the invention may be that optimization of microstructural properties of a metal anode provides an increase in the reversibility of oxidation processes and improved suppression of the hydrogen evolution reaction while preventing or minimizing the need of additives. The dominance of microstructural features on hydrogen evolution reaction and oxidation behavior may diminish in the order of metallurgical phases, dislocation density, crystallographic texture, and grain size. Manipulation of these features allows for increasing the reversibility of oxidation processes. Therefore, the efficiency and lifetime of the metallic materials in metal-air batteries may significantly be increased by engineering the microstructure of metallic materials through the method of the invention. Moreover, the metallurgical manipulations in this invention also allow to improve the stability of the current state-of-the-art solutions for controlling the hydrogen evolution reaction.

The methods of the invention and the resulting electrode may provide a more efficient, durable and cost-effective solution than the state-of-art metal-based anodes. Hence, in this way durable and efficient anode material design for metal-air batteries may be provided.

In embodiments, the invention may provide an electrode comprising an iron comprising material composition. The electrode may especially, in embodiments, be obtainable by a method for producing an electrode as described further below.

The term electrode may herein refer to electrical conductor configured to make contact with a part of an electrical circuit, such as a semiconductor, an electrolyte, vacuum, or air. In embodiments, electrodes may comprise a variety of materials, such as for example one or more metals, see also further below. Hence, the electrode may especially, in embodiments, comprise a material composition comprising one or more metals. Especially, in embodiments, the electrode may comprise an iron comprising material composition.

As may be known in the art, solid iron may have different atom arrangements, i.e., different allotropes. In particular, solid iron may comprise one or more metallurgical phases. Herein, a phase may refer to a region of a material having uniform chemical and physical properties. Hence, a metallurgical phase may refer to a region of a metallic (e.g. iron comprising) material having uniform chemical and physical properties. In embodiments, the iron comprising material composition may comprise one or more of a ferrite phase, an austenite phase, a martensite phase, a pearlite phase, and a bainite phase. Ferrite phase (or “α-iron”) may, in embodiments, comprise iron having a body-centered cubic crystal structure. Austenite phase (or “γ-iron”) may, in embodiments, comprise iron having a face-centered cubic crystal structure. Martensite phase may, in embodiments, comprise iron having a body-centered tetragonal or cubic crystal structure. Especially, in embodiments, martensite phase iron may be obtained through rapid cooling (“quenching”) of austenite phase iron. Therefore, martensite phase may, in embodiments, display prior austenite grain boundaries. Further, in embodiments, moderate cooling of austenite phase iron may yield bainite phase iron. Bainite phase may, in embodiments, comprise iron having a plate-like microstructure. Especially, in embodiments, bainite phase may comprise ferrite alternated with cementite particles. Herein cementite (or “iron-carbide”) may refer to a compound comprising both iron and carbon in the ratio Fe₃C, and having an orthorhombic crystal structure. Yet further, in embodiments, slow cooling of austenite phase iron may yield pearlite phase iron. Pearlite phase may, in embodiments, refer to iron having a eutectoid structure (i.e., a dual-phase structure formed from a single-phase austenite structure during cooling). Especially, in embodiments, pearlite phase may comprise iron having alternating layers (“lamellae”) of cementite and ferrite.

As described, the martensite, bainite, and pearlite phase may be achieved through cooling of austenite phase material. In some embodiments, the transformation of austenite to martensite, bainite, and/or pearlite may be incomplete. In other words, upon cooling (or quenching) not all austenite may be transformed to the desired phase. The austenite that does not transform is called retained austenite. This retained austenite especially occurs when the iron material is not quenched to a temperature low enough to form 100% of the desired phase (e.g. in the case of martensite to a martensite finish temperature above room temperature). In embodiments, retained austenite may cause loss of strength and increased brittleness. Hence, in embodiments, little to no retained austenite in the material composition may be desired, see also further below.

Thus, in embodiments, the iron comprising material composition may comprise at least two (different) metallurgical phases, such as three metallurgical phases, like four metallurgical phases, including five metallurgical phases. Especially, in embodiments, the iron comprising material composition may comprise two or more metallurgical phases selected from the group consisting of: martensite, pearlite, bainite, and ferrite. For example, in embodiments, the iron comprising material composition may comprise ferrite phase and martensite phase iron. In other embodiments, the iron comprising material composition may comprise ferrite phase, bainite phase, and pearlite phase iron. In yet other embodiments, the iron comprising material composition may comprise essentially all of martensite phase, pearlite phase, bainite phase, and ferrite phase iron. However, other combinations of the mentioned metallurgical phases are also possible.

The iron comprising material composition may especially comprise grains (or “crystallites”). During solidification of an iron comprising material, atoms inside the material may form clusters having different crystal orientations. The area between the clusters of atoms with different crystal orientations may be referred to as a grain boundary. A grain may thus, in embodiments, refer to a cluster of atoms (together) having a certain crystal orientation. In embodiments, the grains may have a number averaged circularly equivalent grain diameter D. The number averaged equivalent circular grain diameter D of the grains may especially be defined by the grain boundaries. Especially, a grain may be identified as the area that is circumscribed by a closed surface, i.e., by the grain boundaries. Further, in embodiments, the number averaged equivalent circular grain diameter D of the grains may be in the micrometer range. Especially, in embodiments, the number averaged equivalent circular grain diameter D of the grains may be selected from the range of 0.5-150 μm, such as from the range of 1-120 μm, like from the range of 1-100 μm, especially from the range of 3-90 μm, including from the range of 5-60 μm. The number averaged equivalent circular diameter of a grain may especially be derived from measurements performed using techniques such as electron backscattered diffraction (EBSD).

Here, the term “diameter” may also refer to an equivalent circular diameter. The equivalent circular diameter (or ECD) (or “circular equivalent diameter”) of an (irregularly shaped) two-dimensional shape is the diameter of a circle of equivalent area. For instance, the equivalent circular diameter of a square with side a is 2*a*SQRT(1/π). For a circle, the diameter is the same as the equivalent circular diameter. Would a circle in an xy-plane with a diameter D be distorted to any other shape (in the xy-plane), without changing the area size, than the equivalent circular diameter of that shape would be D.

Herein, the electrode is described to be comprising an iron comprising material composition, i.e., an iron electrode. However, the herein described features may potentially also be used to provide similar effects/improvements for other metal electrodes, such as e.g. aluminum, zinc, or lithium electrodes. Hence, the invention may be of interest in a variety of metal-air or metal-based battery systems.

As described above, the iron comprising material composition (of the electrode) may comprise two or more metallurgical phases. Especially, in embodiments, the iron comprising material composition may comprise (i) one or more of martensite, pearlite and bainite, (ii) ferrite, and optionally (iii) (retained) austenite. In embodiments, the iron comprising material composition may comprise 2-98 vol. %, especially 2-97.9 vol. % of one or more of martensite, pearlite and bainite, such as 5-90 vol. %, like 10-80 vol. %, especially 15-70 vol. %. Further, in embodiments, the iron comprising material composition may comprise 2-95 vol. % ferrite, especially 2-85 vol. % of ferrite, such as 5-80 vol. %, like 10-75 vol. %, especially 15-70 vol. %. Yet further, in embodiments, the iron comprising material composition may comprise at most 10 vol. % of (retained) austenite, such as selected from the range of 0-10 vol. %, especially selected from the range of 0.1-10 vol. %, or like selected from the range of 0-8 vol. %, especially at least 0.1 vol. %, such as selected from the range of 0.1-5 vol. %, especially selected from the range of 0.1-4 vol. %, like selected from the range of 0.5-3 vol. %. Hence, in embodiments, the invention provides the electrode as described above, wherein the iron comprising material composition comprises (i) 2-97.9 vol. % of one or more of martensite, pearlite, and bainite, (ii) 2-85 vol. % ferrite, and (iii) 0.1-10 vol. % austenite. Hence, in specific embodiments, the invention provides an electrode comprising an iron comprising material composition, wherein the iron comprising material composition comprises two or more metallurgical phases selected from the group consisting of: martensite, pearlite, bainite, and ferrite, wherein the iron comprising material composition comprises (i) 2-97.9 vol. % of one or more of martensite, pearlite, and bainite, (ii) 2-85 vol. % ferrite, and (iii) 0.1-10 vol. % austenite; wherein the iron comprising material composition comprises grains, wherein the grains have a number averaged equivalent circular grain diameter D, wherein the number averaged equivalent circular grain diameter D is defined by grain boundaries, wherein the number averaged equivalent circular grain diameter D is selected from the range of 1-100 μm.

Such embodiments may be beneficial as using a dual-phased (or multiple-phased) iron comprising material composition in the electrode may provide improved suppression of the parasitic hydrogen evolution reaction (HER). Further, use of a dual-phased iron comprising material composition in the electrode may promote the reversibility of oxidation and reduction reactions at the electrode, which may increase the lifetime of the electrode.

Furthermore, in specific embodiments, the invention provides an electrode comprising an iron comprising material composition, wherein the iron comprising material composition comprises two or more metallurgical phases selected from the group consisting of: martensite, pearlite, bainite, and ferrite, wherein the iron comprising material composition comprises (i) 2-97.9 vol. % of one or more of martensite, pearlite, and bainite, (ii) 2-85 vol. % ferrite, and (iii) 0.1-10 vol. % austenite; wherein the iron comprising material composition comprises grains, wherein the grains have a number averaged equivalent circular grain diameter D, wherein the number averaged equivalent circular grain diameter D is defined by grain boundaries, wherein the number averaged equivalent circular grain diameter D is selected from the range of 1-100 μm, wherein the iron comprising material composition comprises one or more of: carbon selected from the range of 0.022-4 wt. %; manganese selected from the range of 0.1-4.2 wt. %; silicon selected from the range of 0.01-4 wt. %; sulfur selected from the range of 0.0001-12 wt. %; aluminum selected from the range of 0.01-2 wt. %; copper selected from the range of 0.01-2 wt. %; bismuth selected from the range of 0.001-8.4 wt. %; calcium selected from the range of 0.0001-0.4 wt. %; nitrogen selected from the range of 0.0001-5 wt. %; magnesium selected from the range of 0.0001-0.004 wt. %; zinc selected from the range of 0.0001-5 wt. %; cobalt selected form the range of 0.0001-5 wt. %; and tin selected from the range of 0.0001-0.5 wt. %; with the balance of iron (210) and impurities.

In embodiments, the iron comprising material composition may thus comprise two or more metallurgical phases. Hence, in some embodiments, the iron comprising material composition may comprise at least ferrite and one other metallurgical phase selected from martensite, pearlite and bainite. For example, in such embodiments, the iron comprising material composition may comprise martensite and ferrite. Or in another example, in such embodiments, the iron comprising material composition may comprise bainite and ferrite. Or in yet another example, in such embodiments, the iron comprising material composition may comprise pearlite and ferrite. Further, in embodiments, the iron comprising material composition may comprise ferrite, (at least) one metallurgical phase selected from martensite, pearlite, and bainite, and a third (or fourth or fifth) metallurgical phase. Especially, in such embodiments, the third metallurgical phase may be either (a) another (different) one of martensite, pearlite, and bainite, or (b) (retained) austenite. For example, in embodiments, the iron comprising material composition may comprise ferrite, martensite, and bainite. In another example, in embodiments, the iron comprising material composition may comprise ferrite, martensite, and austenite. In embodiments, other combinations may be feasible as well, such as e.g., ferrite, pearlite and bainite. Yet further, in embodiments, the iron comprising material composition may also comprise all above-described metallurgical phases, i.e., the iron comprising material composition may comprise ferrite, martensite, bainite, pearlite, and austenite.

The iron comprising material composition (of the electrode) may especially comprise at least 90 vol. % in total of ferrite and one or more of martensite, bainite, and pearlite. Hence, in embodiments, the iron comprising material composition may comprise at most 10 vol. % of (retained) austenite, such as at most 6 vol. %, like at most 4 vol. %, especially at most 2 vol. %, including 0 vol. %. Further, in embodiments, the iron comprising material composition may comprise at least 2 vol. %, such as at least 5 vol. %, like at least 20 vol. % especially at least 25 vol. % of ferrite and at least 2 vol. %, such as at least 5 vol. %, like at least 20 vol. % especially at least 25 vol. % of one or more of martensite, bainite, and pearlite. For example, in embodiments, the iron comprising material composition may comprise 50 vol. % ferrite with 50 vol. % of (a combination of) martensite (and/)or bainite (and/)or pearlite. For example, in such embodiments, the iron comprising material composition may comprise 50 vol. % martensite and 50 vol. % ferrite. Or in another example, in such embodiments, the iron comprising material composition may comprise 50 vol. % ferrite with 20 vol. % bainite and 30 vol. % martensite. In yet another example, in embodiments, the iron comprising material composition may comprise 24 vol. % ferrite with 73 vol. % bainite, and 3 vol. % (retained) austenite. These examples serve as illustrations as it may be clear to the person skilled in the art that further combinations may be feasible.

In specific embodiments, the invention provides the electrode as described above, wherein the iron comprising material composition comprises at least 40 vol. %, like at least 50 vol. % bainite, such as at least 60 vol. % bainite, like at least 70 vol. % bainite, especially at least 80 vol. % bainite.

Such embodiments may be beneficial as the effect of the metallurgical phases on the suppression of HER increases in the order of martensite, pearlite, ferrite, to bainite. Additionally, the effect of the metallurgical phases on the reversibility of oxidation and reduction behaviors increases in the order of ferrite, bainite, pearlite, to martensite. Hence, the introduction of bainite phase into ferrite phase iron comprising material may provide improvement in both the reduction of HER and the reversibility of oxidation and reduction.

Similar to engineering metallurgical phases in the iron comprising material composition of the electrode, other features may provide a improved suppression of HER and the reversibility of oxidation and reduction as well. Such a feature may for example be the crystallographic orientation of the grains in the iron comprising material composition.

In particular, in embodiments, grains in the iron comprising material composition may have a crystallographic orientation. Herein the crystallographic orientation may refer to the orientation of a plane in a crystal lattice of the grains with respect to a fixed coordinate system. In other words, a unit cell of the grains may comprise a lattice plane with an orientation relative to a fixed coordinate system (e.g. the Cartesian coordinate system). In cubic structures, the lattice planes may be equivalent to a crystal direction. Therefore, the crystallographic planes may especially be denoted using Miller indices, i.e., <100>, <110>, and <111>. Here, the denotation <110> may refer to a set of all directions that are equivalent to [110] on the basis of symmetry (of the unit cell), i.e., the set comprising [110], [011], [101], [1 −1 0], etc. A <110> crystallographic orientation of a grain may especially mean that the [110] crystallographic direction is parallel to the direction of the reference coordinate system that is the normal of the materials surface. In samples, such crystallographic orientations may be measured using a technique such as neutron diffraction, x-ray diffraction (XRD), or electron backscattered diffraction (EBSD).

In embodiments, the iron comprising material composition (of the electrode) may comprise at least 40 vol. %, such as at least 50 vol. %, like at least 60 vol. %, especially at least 70 vol. % of the grains having a <110> crystallographic orientation.

Hence, in embodiments, the invention provides the electrode as described above, wherein at least 50 vol. % of the grains have a <110> crystallographic orientation.

Such embodiments may be beneficial as the effect of the crystallographic orientation on the suppression of HER increases in the order of <001>, <111>, to <110>. Therefore, it may be beneficial for the electrode to introduce at least 50 vol. % of <110> grains in the iron comprising material composition.

As described above, in embodiments where the grains have a cubic crystal structure (e.g. the body-centered cubic crystal structure of ferrite) the indication of the lattice planes may be equivalent to the indication of the crystal direction. In embodiments, for at least 50 vol. % of the grains, the crystallographic orientation may be a diagonal lattice plane, i.e., indicated by the diagonal crystal direction [110]. Due to symmetry in the crystal structure, the [110] crystal direction may, in embodiments, be essentially equal to (and hence denoted as) any one of [101], [011], [−1−10], [0−1−1], [−10−1], [−110], [0−11], [−101], [1−10], [01−1], and [10−1], i.e., the <110> family. However, in embodiments, at least part of the grains may (also) have a different crystal orientation, such as a <100> orientation, or such as a <111> orientation. For example, in embodiments, at least 20 vol. %, such as at least 40 vol. % of the grains may have a [111] crystallographic orientation.

Further, another feature that may provide a positive influence on HER and the reversibility of oxidation and reduction may be the grain diameter. Therefore, in embodiments, for the electrode may apply that at least part of a total number of the grains may comprise phase grains. Especially, in such embodiments, the martensite phase grains may have an average prior austenite grain size, as martensite phase grains may display prior austenite grain boundaries. Herein the average prior austenite grain size is referred to as a number averaged circularly equivalent diameter Dₘ selected from the range of 23-98 μm. Additionally or alternatively, for the electrode may apply that at least part of the total number of the grains may comprise bainite phase grains. Especially, in such embodiments, the bainite phase grains may have a number averaged circularly equivalent diameter D_{b} selected from the range of 3-60 μm. Additionally or alternatively, for the electrode may apply that at least part of the total number of the grains may comprise pearlite phase grains (also called pearlite colonies). Especially, in such embodiments, the pearlite phase grains may have a number averaged circularly equivalent diameter Dₚ selected from the range of 3-60 μm. Additionally or alternatively, for the electrode may apply that at least part of the total number of the grains may comprise ferrite phase grains. Especially, in such embodiments, the ferrite phase grains may have a number averaged circularly equivalent diameter D_{f} selected from the range of 3-80 μm. Hence, in embodiments, the invention may provide the electrode as described above, wherein one or more of the following applies: (a) at least part of a total number of the grains comprise martensite phase grains, wherein the martensite phase grains have a number averaged equivalent circular grain diameter Dₘ selected from the range of 23-98 μm; (b) at least part of a total number of the grains comprise bainite phase grains, wherein the bainite phase grains have a number averaged equivalent circular grain diameter D_{b} selected from the range of 3-60 μm; (c) at least part of a total number of the grains comprise pearlite phase grains, wherein the pearlite phase grains have a number averaged equivalent circular grain diameter Dₚ selected from the range of 3-60 μm; and (d) at least part of a total number of the grains comprise ferrite phase grains, wherein the ferrite phase grains have a number averaged equivalent circular grain diameter D_{f} selected from the range of 3-80 μm.

Such embodiments may be beneficial as a relatively small grain diameter may promote the reversibility of oxidation and reduction reactions at the electrode, therefore promoting the lifetime of the electrode. The effect of the grain diameter on the reversibility of oxidation and reduction reactions depends on the phase of the grains, therefore, the different phases may have different preferred grain diameter ranges. Furthermore, refinement of grain size may also promote the formation of inclusions (see also further below) at the grain boundaries and therefore the effect of inclusions on the stability of the material and the stable oxide formation.

In embodiments, the electrode may thus comprise an iron comprising material composition comprising a total number of grains. At least part of the total number of grains, such as at least 10 vol. %, like at least 25 vol. %, especially at least 40 vol. % may, in embodiments, comprise martensite phase grains. Especially, in embodiments, at least 50 vol. %, such as at least 60 vol. %, like at least 70 vol. %, especially at least 80 vol. % of the total number of grains may comprise martensite phase grains. Martensite phase grains may have a number averaged equivalent circular grain diameter Dₘ. In embodiments, the martensite phase number averaged equivalent circular grain diameter Dₘ may be selected from the range of 15-100 μm, such as from the range of 23-98 μm, like from the range of 25-95 μm, especially from the range of 25-80 μm, such as from the range of 30-60 μm.

Additionally or alternatively, at least part of the total number of grains, such as at least 10 vol. %, like at least 25 vol. %, especially at least 40 vol. %, may, in embodiments, comprise bainite phase grains. Especially, in embodiments, at least 50 vol. %, such as at least 60 vol. %, like at least 70 vol. %, especially at least 80 vol. % of the total number of grains may comprise bainite phase grains. Bainite phase grains may have a number averaged equivalent circular grain diameter D_{b}. In embodiments, the bainite phase number averaged equivalent circular grain diameter D_{b} may be selected from the range of 3-100 μm, such as from the range of 3-80 μm, like from the range of 3-60 μm, especially from the range of 5-45 μm, such as from the range of 10-30 μm.

Additionally or alternatively, at least part of the total number of grains, such as at least 10 vol. %, like at least 25 vol. %, especially at least 40 vol. %, may, in embodiments, comprise pearlite phase grains. Especially, in embodiments, at least 50 vol. %, such as at least 60 vol. %, like at least 70 vol. %, especially at least 80 vol. % of the total number of grains may comprise pearlite phase grains. Pearlite phase grains may have a number averaged equivalent circular grain diameter Dₚ. In embodiments, the pearlite phase number averaged equivalent circular grain diameter Dₚ may be selected from the range of 3-100 μm, such as from the range of 3-80 μm, like from the range of 3-60 μm, especially from the range of 5-45 μm, such as from the range of 10-30 μm.

Additionally or alternatively, at least part of the total number of grains, such as at least 10 vol. %, like at least 25 vol. %, especially at least 40 vol. %, may, in embodiments, comprise ferrite phase grains. Especially, in embodiments, at least 50 vol. %, such as at least 60 vol. %, like at least 70 vol. %, especially at least 80 vol. % of the total number of grains may comprise ferrite phase grains. Ferrite phase grains may have a number averaged equivalent circular grain diameter D_{f}. In embodiments, the ferrite phase number averaged equivalent circular grain diameter D_{f} may be selected from the range of 3-100 μm, such as from the range of 3-80 μm, like from the range of 3-60 μm, especially from the range of 5-45 μm, such as from the range of 10-30 μm.

Yet further, another feature that may provide improved suppression of HER and the reversibility of oxidation and reduction may be dislocation density. Increasing the dislocation density in the iron comprising material composition may lead to a decrease in stable oxide and hydroxide formation on the electrode. Therefore, it may be desired to have a relatively high dislocation density. Hence, in embodiments, the invention provides the electrode as described above, wherein the iron comprising material composition comprises a dislocation density ρ_{d}, wherein ρ_{d}≥10¹² m⁻², wherein the dislocation density ρ_{d} is defined by the Nye dislocation density tensor.

Total dislocation density in metallurgy may, in embodiments, comprise a combination of statistically stored dislocations and geometrically necessary dislocations. Statistically stored dislocations may especially be formed during formation and plastic deformation of the iron comprising material composition, when increase of the number of dislocations leads to chance encounters between the dislocations. Geometrically necessary dislocations as the name indicates are necessary to maintain geometric compatibility between grains during plastic deformation (through thermal and/or thermomechanical processing) in the material. In embodiments, the geometrically necessary dislocations are caused by geometrical constraints of the crystal lattice and may correct overlaps and voids occurring between grains. The dislocation density may be estimated by performing electron backscatter diffraction (EBSD) analysis on the iron comprising material composition and applying the Nye dislocation density tensor on the obtained data. The Nye dislocation density tensor is determined by the tensorial addition of lattice curvature (or orientation curl) and the divergence of the elastic strain tensor.

In embodiments, the electrode may thus comprise the iron comprising material composition comprising a dislocation density ρ_{d}. Especially, in embodiments, the dislocation density ρ_{d} may comprise geometrically necessary dislocations and statistically stored dislocations. In embodiments, the dislocation density may especially be in the order of at least 5*10¹¹ m⁻², such as at least 10¹² m⁻², such as in the order of at least 10¹³ m⁻², like in the order of at least 10¹⁴ m⁻². Hence, in embodiments, ρ_{d}≥10¹² m⁻², especially ρ_{d}≥10¹³ m⁻².

Further, in embodiments, the electrode may comprise multiple phases of matter, such as a (metal) powder and a substantially inert (i.e. non-reactive) material such as carbon or a polymeric binder. The addition of a substantially inert material may improve the electrochemical and/or mechanical properties of the electrode. For example, the iron comprising material composition in the electrode may comprise powdered iron and a binder material, wherein the binder may be added to improve the mechanical integrity of the electrode. In certain other embodiments, the iron comprising material composition in the electrode may comprise powdered iron and a carbon material, wherein the carbon may be added to improve the electrical conductivity of the electrode. In yet other embodiments, the iron comprising material composition in the electrode may comprise powdered iron, and both a binder material, and carbon. Thus, in embodiments, the iron comprising material composition may (also) comprise materials such as carbon, nitrogen, and other (transition) metals. Especially, in embodiments, the electrode may comprise the iron comprising material composition (further) comprising carbon, manganese, silicon, sulfur, aluminum, copper, bismuth, calcium, nitrogen, magnesium, and tin.

In embodiments, the iron comprising material composition may especially comprise carbon selected from the range of 0-4 wt. %, more especially selected from the range of 0.022-4 wt. %, such as selected from the range of 0.03-2 wt. %, like from the range of 0.1-1 wt. %. The carbon may, for example, be present in the form of cementite (Fe₃C) as described above. Further, in embodiments, the iron comprising material composition may especially comprise manganese selected from the range of 0-4.2 wt. %, more especially selected from the range of 0.1-4.2 wt. %, such as selected from the range of 0.1-4 wt. %, like from the range of 0.5-2 wt. %. Yet further, in embodiments, the iron comprising material composition may especially comprise silicon selected from the range of 0-4 wt. %, more especially selected from the range of 0.01-4 wt. %, such as selected from the range of 0.05-2 wt. %, like from the range of 0.1-2 wt. %. Yet further, in embodiments, the iron comprising material composition may especially comprise sulfur selected from the range of 0-12 wt. %, more especially selected from the range of 0.0001-12 wt. %, such as selected from the range of 0.0005-5 wt. %, like from the range of 0.001-0.1 wt. %. Yet further, in embodiments, the iron comprising material composition may especially comprise aluminum selected from the range of 0-2 wt. %, more especially selected from the range of 0.01-2 wt. %, such as selected from the range of 0.02-0.05 wt. %, like from the range of 0.02-0.04 wt. %. Yet further, in embodiments, the iron comprising material composition may especially comprise copper selected from the range of 0-2 wt. %, more especially selected from the range of 0.01-2 wt. %, such as selected from the range of 0.01-0.1 wt. %, like from the range of 0.02-0.04 wt. %. In specific embodiments, the invention may provide an iron comprising material composition, wherein the iron comprising material composition comprises two or more metallurgical phases selected from the group consisting of: martensite, pearlite, bainite, and ferrite, wherein the iron comprising material composition comprises (i) 2-97.9 vol. % of one or more of martensite, pearlite, and bainite, (ii) 2-85 vol. % ferrite, and (iii) 0.1-10 vol. % austenite; wherein the iron comprising material composition comprises one or more of: carbon selected from the range of 0.022-4 wt. %; manganese selected from the range of 0.1-4.2 wt. %; silicon selected from the range of 0.01-4 wt. %; sulfur selected from the range of 0.0001-12 wt. %; aluminum selected from the range of 0.01-2 wt. %; copper selected from the range of 0.01-2 wt. %; with the balance of iron and impurities (see also further below).

Yet further, in embodiments, the iron comprising material composition may especially comprise bismuth selected from the range of 0-8.4 wt. %, more especially selected from the range of 0.001-8.4 wt. %, such as selected from the range of 0.005-8 wt. %, like from the range of 0.01-4 wt. %. Yet further, in embodiments, the iron comprising material composition may especially comprise calcium selected from the range of 0-0.4 wt. %, more especially selected from the range of 0.0001-0.4 wt. %, such as selected from the range of 0.0005-0.2 wt. %, like from the range of 0.001-0.1 wt. %. Yet further, in embodiments, the iron comprising material composition may especially comprise nitrogen selected from the range of 0-5 wt. %, more especially selected from the range of 0.0001-5 wt. %, such as selected from the range of 0.0005-1 wt. %, like from the range of 0.001-0.05 wt. %. Yet further, in embodiments, the iron comprising material composition may especially comprise magnesium selected from the range of 0-0.004 wt. %, more especially selected from the range of 0.0001-0.004 wt. %, such as selected from the range of 0.0001-0.001 wt. %, like from the range of 0.0002-0.0004 wt. %. Yet further, in embodiments, the iron comprising material composition may especially comprise zinc selected from the range of 0-5 wt. %, more especially selected from the range of 0.0001-5 wt. %, such as selected from the range of 0.0005-1 wt. %, like from the range of 0.001-0.5 wt. %. Yet further, in embodiments, the iron comprising material composition may especially comprise cobalt selected from the range 0-5 wt. %, more especially selected from the range of 0.0001-5 wt. %, such as selected from the range of 0.0005-1 wt. %, like from the range of 0.001-0.5 wt. %. Yet further, in embodiments, the iron comprising material composition may especially comprise tin selected from the range of 0-0.5 wt. %, more especially selected from the range of 0.0001-0.1 wt. %, such as selected from the range of 0.0005-0.05 wt. %, like from the range of 0.0005-0.01 wt. %.

For example, in embodiments, the iron comprising material composition may comprise: (A) carbon selected from the range of 0.022-4 wt. %; manganese selected from the range of 0.1-4.2 wt. %; silicon selected from the range of 0.01-4 wt. %; sulfur selected from the range of 0.0001-12 wt. %; aluminum selected from the range of 0.01-2 wt. %; copper selected from the range of 0.01-2 wt. %; (B) one or more of bismuth selected from the range of 0.001-8.4 wt. %; calcium selected from the range of 0.0001-0.4 wt. %; nitrogen selected from the range of 0.0001-5 wt. %; magnesium selected from the range of 0.0001-0.004 wt. %; zinc selected from the range of 0.0001-5 wt. %; cobalt selected form the range of 0.0001-5 wt. %; and tin selected from the range of 0.0001-0.5 wt. %; and (C) with the balance of iron and impurities

In embodiments, the iron comprising material composition may thus comprise impurities, such as for example traces of one or more of oxygen, phosphorous and hydrogen. Therefore, in embodiments, the iron comprising material composition may thus comprise a plurality of elements with the balance of iron and (unavoidable) impurities. Hence, in embodiments, the invention provides the electrode as described above, wherein the iron comprising material composition comprises one or more of: (i) carbon selected from the range of 0.022-4 wt. %, (ii) manganese selected from the range of 0.1-4.2 wt. %, (iii) silicon selected from the range of 0.01-4 wt. %, (iv) sulfur selected from the range of 0.0001-12 wt. %, (v) aluminum selected from the range of 0.01-2 wt. %, (vi) copper selected from the range of 0.01-2 wt. %, (vii) bismuth selected from the range of 0.001-8.4 wt. %, (viii) calcium selected from the range of 0.0001-0.4 wt. %, (ix) nitrogen selected from the range of 0.0001-5 wt. %, (x) magnesium selected from the range of 0.0001-00004 wt. %, (xi) zinc selected from the range of 0.0001-5 wt. %, (xii) cobalt selected from the range of 0.0001-5 wt. %, and (xiii) tin selected from the range of 0.0001-0.5 wt. %, with the balance of iron and impurities. In specific embodiments, the invention provides an iron comprising material composition, wherein the iron comprising material composition comprises two or more metallurgical phases selected from the group consisting of: martensite, pearlite, bainite, and ferrite, wherein the iron comprising material composition comprises (i) 2-97.9 vol. % of one or more of martensite, pearlite, and bainite, (ii) 2-85 vol. % ferrite, and (iii) 0.1-10 vol. % austenite; wherein the iron comprising material composition comprises one or more of: carbon selected from the range of 0.022-4 wt. %; manganese selected from the range of 0.1-4.2 wt. %; silicon selected from the range of 0.01-4 wt. %; sulfur selected from the range of 0.0001-12 wt. %; aluminum selected from the range of 0.01-2 wt. %; copper selected from the range of 0.01-2 wt. %; bismuth selected from the range of 0.001-8.4 wt. %; calcium selected from the range of 0.0001-0.4 wt. %; nitrogen selected from the range of 0.0001-5 wt. %; magnesium selected from the range of 0.0001-0.004 wt. %; zinc selected from the range of 0.0001-5 wt. %; cobalt selected form the range of 0.0001-5 wt. %; and tin selected from the range of 0.0001-0.5 wt. %; with the balance of iron and impurities.

Presence of elements as described above may be the result of the (thermal and/or thermomechanical) processing necessary to obtain the desired microstructures (i.e., to obtain the metallurgical phases, grain diameters, dislocation density and crystallographic orientations as described above) in the electrode. Therefore, adjusting the iron comprising material composition of the electrode to contain the above-described elements may be beneficial for processual manipulation and the resulting efficiency and lifetime of the electrode.

For example, in embodiments, the electrode may comprise the iron comprising material composition as described herein, wherein the iron comprising material composition may especially comprise one or more of carbon selected from the range of 0.022-4 wt. %, manganese selected from the range of 0.1-4.2 wt. %, silicon selected from the range of 0.01-4 wt. %, aluminum selected from the range of 0.01-2 wt. %, and copper selected from the range of 0.01-2 wt. %.

Herein, the phrase “X may comprise a % of A and b % of B with the balance of Y” and similar phrases may indicate that unspecified parts of X may comprise Y. In other words, X may comprise a % of A, b % of B and the balance or “remainder” (i.e., 100%−a %−b %) of Y. For example, in embodiments, the iron comprising material composition may comprise 2 wt. % carbon, 0.5 wt. % of sulfur, 4 wt. % of bismuth, 1 wt. % zinc, and the balance (or “remainder”) of iron. In such embodiments, the iron comprising material composition may thus comprise (100−2−0.5−4−1=) 92.5 wt. % iron.

In embodiments, the iron comprising material composition of the electrode may comprise an iron matrix. In other words, the iron in the composition may form an organized structure, which may, in embodiments, be interspersed with other elements, e.g., the iron comprising material composition may be alloyed iron. In embodiments, the iron matrix may thus comprise one or more of the above-described elements interspersed within the iron. Especially, in embodiments, the iron matrix may comprise at least 50 wt. % iron, such as at least 60 wt. %, like at least 70 wt. %, especially at least 80 wt. %. Furthermore, in embodiments, the iron matrix may comprise (active) inclusions. The inclusions may, in embodiments, be compounds added to the iron matrix for example to provide stability, electrical conductivity, and micro-galvanic coupling. In embodiments, the iron comprising material composition may comprise inclusions selected from the range of 0.1-10 wt. %, such as from the range of 0.5-8 wt. %, like from the range of 1-4 wt. %, or such as from the range of 0.1-2 wt. %. The inclusions may especially, in embodiments, comprise one or more of: (i) a metal sulfide, (ii) a metal oxide, and (iii) a metal nitride. Herein, in embodiments, the metal of the metal sulfide/oxide/nitride may be selected from the group comprising: aluminum, manganese, copper, iron, cobalt, zinc, bismuth, lead, mercury, indium, gallium, and tin.

In particular, in embodiments, the electrode, especially the iron comprising material composition, may comprise at least 80 wt. % iron, such as at least 90 wt. % iron, especially at least 95 wt. % iron. The iron comprising material composition may especially, in embodiments, comprise one or more of carbon, manganese, silicon, sulfur, aluminum, copper, bismuth, calcium, nitrogen, magnesium, tin, at least 90 wt. % iron and potential impurities. Especially, in embodiments, the iron comprising material composition may comprise an iron matrix. In such embodiments, the iron matrix may comprise at least 90 wt. % iron. The iron matrix may further, in embodiments, comprise 0.1-10 wt. % (active) inclusions. In embodiments, the inclusions may comprise one or more of the above-described elements. Especially, in embodiments, the inclusions may comprise one or more of calcium aluminate (CaAl₂O₄), manganese(II)sulfide (MnS), bismuth sulfide (Bi₂S₃), silicon dioxide (SiO₂), nitridomanganese (MnN), copper sulfide (CuS), bismuth oxide (Bi₂O₃), iron sulfide (FeS), cobalt sulfide (CoS), zinc sulfide (ZnS), copper oxide (CuO), aluminum oxide (Al₂O₃), manganese oxide (MnO), manganese dioxide (MnO₂), cobalt oxide (CoO), zinc oxide (ZnO), silicon nitride (Si₃N₄), zinc nitride (Zn₃N₂), bismuth nitride (Bi₃N), and cobalt nitride (Co₃N). Hence, in embodiments, the invention provides the electrode as described above, wherein the iron comprising material composition comprises an iron matrix, wherein the iron matrix comprises at least 90 wt. % iron and 0.1-10 wt. % inclusions, wherein the inclusions comprise one or more of CaAl₂O₄ selected from the range of 0.0001-0.01 wt. %, MnS selected from the range of 0.01-4 wt. %, Bi₂S₃ selected from the range of 0.1-8 wt. %, SiO₂ selected from the range of 0.01-2 wt. %, MnN selected from the range of 0.001-4 wt. %, CuS selected from the range of 0.001-5 wt. %, Bi₂O₃ selected from the range of 0.1-8 wt. %, FeS selected from the range of 0.001-10 wt. %, CoS selected from the range of 0.1-4 wt. %, ZnS selected from the range of 0.001-5 wt. %, CuO selected from the range of 0.001-5 wt. %, Al₂O₃ selected from the range of 0.001-2 wt. %, MnO selected from the range of 0.01-2 wt. %, MnO₂ selected from the range of 0.01-2 wt. %, CoO selected from the range of 0.001-5 wt. %, ZnO selected from the range of 0.001-5 wt. %, Si₃N₄ selected from the range of 0.01-2 wt. %, Zn₃N₂ selected from the range of 0.001-0.5 wt. %, Bi₃N selected from the range of 0.1-5 wt. %, Co₃N selected from the range of 0.001-2 wt. %.

Such inclusions may be beneficial as they may provide a micro-galvanic effect with the iron matrix, thereby increasing the overpotential to HER and therefore lowering HER rate. Refining grain diameters as described above may further promote segregation of the inclusions at the grain boundaries, which may be beneficial for promoting the micro-galvanic effect. Furthermore, the inclusions may govern the oxidation and reduction behavior of the electrode, especially increasing the reversibility of oxidation and reduction reactions at the electrode.

The inclusions as described here may especially be inclusions dominant in the iron comprising material composition. In embodiments, other inclusions (such as e.g. CaO and CaS) may be present as well.

In embodiments, the inclusions may comprise CaAl₂O₄ selected from the range of 0-0.01 wt. %, more especially selected from the range of 0.0001-0.01 wt. %, such as from the range of 0.0005-0.01 wt. %, like from the range of 0.001-0.005 wt. %. Additionally or alternatively, in embodiments, the inclusions may comprise MnS selected from the range of 0-4 wt. %, more especially selected from the range of 0.01-4 wt. %, such as from the range of 0.05-2 wt. %, like from the range of 0.1-1 wt. %. Additionally or alternatively, in embodiments, the inclusions may comprise Bi₂S₃ selected from the range of 0-8 wt. %, more especially selected from the range of 0.1-8 wt. %, such as from the range of 0.5-6 wt. %, like from the range of 1-3 wt. %. Additionally or alternatively, in embodiments, the inclusions may comprise SiO₂ selected from the range of 0-2 wt. %, more especially selected from the range of 0.01-2 wt. %, such as from the range of 0.01-1 wt. %, like from the range of 0.05-1 wt. %. Additionally or alternatively, in embodiments, the inclusions may comprise MnN selected from the range of 0-4 wt. %, more especially selected from the range of 0.001-4 wt. %, such as from the range of 0.005-2 wt. %, like from the range of 0.01-1 wt. %. Additionally or alternatively, in embodiments, the inclusions may comprise CuS selected from the range of 0-5 wt. %, more especially selected from the range of 0.001-5 wt. %, such as from the range of 0.005-3 wt. %, like from the range of 0.01-1 wt. %. Additionally or alternatively, in embodiments, the inclusions may comprise Bi₂O₃ selected from the range of 0-8 wt. %, more especially selected from the range of 0.1-8 wt. %, such as from the range of 0.2-5 wt. %, like from the range of 0.5-3 wt. %. Additionally or alternatively, in embodiments, the inclusions may comprise FeS selected from the range of 0-10 wt. %, more especially selected from the range of 0.001-10 wt. %, such as from the range of 0.005-8 wt. %, like from the range of 0.01-4 wt. %. Additionally or alternatively, in embodiments, the inclusions may comprise CoS selected from the range of 0-4 wt. %, more especially selected from the range of 0.1-4 wt. %, such as from the range of 0.2-2 wt. %, like from the range of 0.5-1 wt. %. Additionally or alternatively, in embodiments, the inclusions may comprise ZnS selected from the range of 0-5 wt. %, more especially selected from the range of 0.001-5 wt. %, such as from the range of 0.005-2 wt. %, like from the range of 0.01-1 wt. %. Additionally or alternatively, in embodiments, the inclusions may comprise CuO selected from the range of 0-5 wt. %, more especially selected from the range of 0.001-5 wt. %, such as from the range of 0.005-2 wt. %, like from the range of 0.01-1 wt. %. Additionally or alternatively, in embodiments, the inclusions may comprise Al₂O₃ selected from the range of 0-2 wt. %, more especially selected from the range of 0.001-2 wt. %, such as from the range of 0.005-1 wt. %, like from the range of 0.01-0.5 wt. %. Additionally or alternatively, in embodiments, the inclusions may comprise MnO selected from the range of 0-2 wt. %, more especially selected from the range of 0.01-2 wt. %, such as from the range of 0.05-1 wt. %, like from the range of 0.1-0.5 wt. %. Additionally or alternatively, in embodiments, the inclusions may comprise MnO₂ selected from the range of 0-2 wt. %, more especially selected from the range of 0.01-2 wt. %, such as from the range of 0.05-1 wt. %, like from the range of 0.1-0.5 wt. %. Additionally or alternatively, in embodiments, the inclusions may comprise CoO selected from the range of 0-5 wt. %, more especially selected from the range of 0.001-5 wt. %, such as from the range of 0.005-2 wt. %, like from the range of 0.01-1 wt. %. Additionally or alternatively, in embodiments, the inclusions may comprise ZnO selected from the range of 0-5 wt. %, more especially selected from the range of 0.001-5 wt. %, such as from the range of 0.005-2 wt. %, like from the range of 0.01-1 wt. %. Additionally or alternatively, in embodiments, the inclusions may comprise Si₃N₄ selected from the range of 0-2 wt. %, more especially selected from the range of 0.01-2 wt. %, such as from the range of 0.05-1 wt. %, like from the range of 0.1-0.5 wt. %. Additionally or alternatively, in embodiments, the inclusions may comprise Zn₃N₂ selected from the range of 0-0.5 wt. %, more especially selected from the range of 0.001-0.5 wt. %, such as from the range of 0.005-0.1 wt. %, like from the range of 0.01-0.1 wt. %. Additionally or alternatively, in embodiments, the inclusions may comprise Bi₃N selected from the range of 0-5 wt. %, more especially selected from the range of 0.1-5 wt. %, such as from the range of 0.5-3 wt. %, like from the range of 1-1.5 wt. %. Additionally or alternatively, in embodiments, the inclusions may comprise Co₃N selected from the range of 0-2 wt. %, more especially selected from the range of 0.001-2 wt. %, such as from the range of 0.005-1 wt. %, like from the range of 0.01-0.5 wt. %.

In embodiments, the inclusions may be present throughout the iron comprising material composition. The inclusions may, in embodiments, especially aggregate. Especially, in embodiments, the inclusions may aggregate to form micro-galvanic coupling sites. Hence, through aggregation of the inclusions micro-galvanic coupling may occur, i.e., metallic inclusions may corrode in favor of the iron in the iron matrix such that the lifetime of the iron may be increased. Herein, the phrase “micro-galvanic coupling sites” may thus refer to locations (or “sites”) in the iron comprising material composition where micro-galvanic coupling may occur. Further, in embodiments, the inclusions may especially aggregate at (or around) the grain boundaries. Especially, in embodiments, at least 70%, such as at least 80%, like at least 90% of the inclusions may be configured (aggregated) at the grain boundaries.

Hence, in embodiments, the inclusions may be configured in the iron comprising material composition to provide micro-galvanic coupling. Additionally or alternatively, in embodiments, the inclusions may be configured in the iron comprising material composition to govern the oxidation and reduction behavior of the iron comprising material composition, especially inclusions may lower the stability and formation of stable oxides and hydroxides on the electrode, thus increasing its lifetime.

The electrode may thus undergo (micro-)galvanic corrosion. In galvanic cells, such corrosion occurs at the anode as electrons are generated at the anode. In other words, during an electrochemical reaction the anode may undergo oxidation, which involves the loss of electrons. During oxidation, the anode releases electrons into its surrounding solution, which can then be used to power other chemical reactions or to generate an electrical current. Therefore, in embodiments, the electrode may especially be an anode.

Furthermore, in embodiments, the electrode may have a coulombic efficiency (or “Faradaic efficiency”) (E_{C}), calculated in a half cell. The coulombic efficiency may describe the charge efficiency by which electrons are transferred when operating the electrode in a cell. Especially, in embodiments, the coulombic efficiency (E_{C}) (calculated in a half cell) may be at least 90%, i.e., E_{C}≥90%, especially E_{C}≥95%, such as E_{C}≥97%, like E_{C}≥99%.

The invention may further provide the electrode as described above, wherein the iron comprising material composition may be provided as layer (on a support material) or body, such as especially as a layer (on a support material), or such as especially as a body. For example, in embodiments, the electrode may be provided as a block, a pellet, a particulate material or agglomerates, a plate, a sheet, or a foil of the iron comprising material composition. Hence, in some embodiments, the iron comprising material composition may be provided as a body, such that the iron comprising material composition may essentially make up the shape of the electrode. Especially, in embodiments, the electrode may have a three-dimensional shape selected from one of a plate(-like) shape, a block(-like) shape, a rod(-like) shape, and a disc(-like) shape. In specific embodiments, the electrode may be a pressed-plate iron electrode, i.e., the electrode may have a block(-like) shape consisting of a plurality of (iron comprising material composition) plates. However, in other embodiments, the iron comprising material composition may be provided as a layer. Especially, in such embodiments, the electrode may comprise a support and the iron comprising material composition, such that the support may be configured to support the layer (of iron comprising material composition), i.e., the layer (of iron comprising material composition) may be deposited onto the support to provide the electrode. In embodiments, the support may comprise a conductive material, however this may not necessarily be the case. For example, in embodiments, the support may comprise one or more of copper, graphite, and a noble metal.

In certain embodiments it may be advantageous for the electrode to be porous, such that it may allow liquid electrolyte to infiltrate the electrode. In such a way, the surface area of contact between the metal electrode and liquid electrolyte may be increased and rapid ion transport through the electrode may be provided. Hence, in embodiments, the electrode may especially be porous. A porous electrode may refer to a composite solid comprising interconnected void spaces, which may take up a significant position of the volume of the electrode. Such porosity may improve the electrochemical behavior, especially the efficiency, capacity and selectivity, of the electrode relative to planar electrodes. Therefore, in embodiments, the layer or body may comprise a porosity (Φ). The porosity (Φ) (of an electrode) may especially be determined using one or more techniques such as mercury intrusion porosimetry (MIP), gas adsorption (e.g. nitrogen adsorption and Brunauer-Emmett-Teller (BET) analysis), scanning electron microscopy (SEM), x-ray microtomography (micro-CT), helium pycnometry, gravimetric analysis, and application of the Archimedes principle. Especially, the porosity may be determined via a direct method, such as especially determining the bulk volume of the porous sample, and then determining the volume of the skeletal material with no pores (pore volume=total volume−material volume). Alternatively, the porosity may be determined via an optical method, such as especially determining the area of the material versus the area of pores visible under the microscope. Alternatively, the porosity may be determined using especially mercury intrusion porosimetry (MIP). Alternatively, especially X-ray microtomography may be applied.

In embodiments, the porosity (Φ) of the layer or body may be selected from the range of 10-95 vol. %, such as from the range of 12-75 vol. %, like from the range of 15-65 vol. %, especially from the range of 25-50 vol. %. However, in other embodiments, it may be advantageous to have a dense electrode to minimize its volume.

In a further aspect, the invention also provides the iron comprising material composition, as described above. Especially, in embodiments, the iron comprising material composition may comprise two or more metallurgical phases selected from the group consisting of: martensite, pearlite, bainite, and ferrite. Further, in embodiments, the iron comprising material composition may comprise grains. The grains may especially have a number averaged equivalent circular grain diameter D. In embodiments, the number averaged equivalent circular grain diameter D may be defined by grain boundaries. Further, in embodiments, the number averaged equivalent circular grain diameter D may be selected from the range of 1-100 μm, such as from the range of 3-90 μm, like from the range of 5-60 μm. Yet further, in embodiments, the iron comprising material composition may comprise one or more of carbon, manganese, silicon, sulfur, aluminum, copper, bismuth, calcium, nitrogen, magnesium, zinc, cobalt, and tin, see also above. Hence, in specific embodiments, the invention provides an iron comprising material composition, wherein the iron comprising material composition comprises two or more metallurgical phases selected from the group consisting of: martensite, pearlite, bainite, and ferrite; wherein the iron comprising material composition comprises grains, wherein the grains have a number averaged grain diameter D, wherein the number averaged grain diameter D is defined by grain boundaries, wherein the number averaged grain diameter D is selected from the range of 1-100 μm; wherein the iron comprising material composition comprises one or more of: (i) carbon selected from the range of 0.022-4 wt. %, (ii) manganese selected from the range of 0.1-4.2 wt. %, (iii) silicon selected from the range of 0.01-4 wt. %, (iv) sulfur selected from the range of 0.0001-12 wt. %, (v) aluminum selected from the range of 0.01-2 wt. %, (vi) copper selected from the range of 0.01-2 wt. %, (vii) bismuth selected from the range of 0.001-8.4 wt. %, (viii) calcium selected from the range of 0.0001-0.4 wt. %, (ix) nitrogen selected from the range of 0.0001-5 wt. %, (x) magnesium selected from the range of 0.0001-0.004 wt. %, (xi) zinc selected from the range of 0.0001-5 wt. %, (xii) cobalt selected from the range of 0.0001-5 wt. %, and (xiii) tin selected from the range of 0.0001-0.5 wt. %, with the balance of iron and impurities.

The iron comprising material composition may, in embodiments, especially comprise (i) one or more of martensite, pearlite, and bainite, (ii) ferrite, and optionally (iii) (retained) austenite. Especially, in such embodiments, the iron comprising material composition may comprise 2-98 vol. %, especially 2-94.9 vol. % of one or more of martensite, pearlite, and bainite, such as 5-90 vol. %, like 10-80 vol. %, especially 15-70 vol. %. Further, in such embodiments, the iron comprising material composition may comprise 5-70 vol. %, such as 10-60 vol. %, like 20-50 vol. % of ferrite. Yet further, in such embodiments, the iron comprising material composition may comprise retained austenite, such as selected from the range of 0-10 vol. %, like from the range of 0-8 vol. %, especially from the range of 0.1-4 vol. %. Hence, in embodiments, the iron comprising material composition comprises (i) 2-94.9 vol. % of one or more of martensite, pearlite, and bainite, and (ii) 5-70 vol. % ferrite, and 0.1-10 vol. % austenite. In specific embodiments, the iron comprising material composition comprises at least 50 vol. % bainite. For example, in embodiments, the iron comprising material composition may comprise 60 vol. % bainite, 25 vol. % ferrite, 13 vol. % martensite, and 2 vol. % austenite.

Further features of the iron comprising material composition have been described in further detail above and will be shortly repeated below.

Especially, in embodiments, the at least 40 vol. %, such as at least 50 vol. % of the grains (in the iron comprising material composition) have a <110> crystallographic orientation.

Further, in embodiments, for the iron comprising material composition, one or more of the following applies: (i) at least part of a total number of the grains comprise martensite phase grains, wherein the martensite phase grains have a number averaged equivalent circular grain diameter (Dₘ) selected from the range of 23-98 μm; (ii) at least part of a total number of the grains comprise bainite phase grains, wherein the bainite phase grains have a number averaged equivalent circular grain diameter (D_{b}) selected from the range of 3-60 μm; (iii) at least part of a total number of the grains comprise pearlite phase grains, wherein the pearlite phase grains have a number averaged equivalent circular grain diameter (Dₚ) selected from the range of 3-60 μm; (iv) at least part of a total number of the grains comprise ferrite phase grains, wherein the ferrite phase grains have a number averaged equivalent circular grain diameter (D_{f}) selected from the range of 3-80 μm.

Yet further, in embodiments, the iron comprising material composition comprises a dislocation density ρ_{d} (especially comprising geometrically necessary dislocations and statistically stored dislocations), wherein ρ_{d}≥10¹² m⁻².

As described above, in embodiments, the iron comprising material composition may comprise an iron matrix. In other words, the iron in the composition may form an organized structure, which may, in embodiments, be interspersed with other element, e.g., the iron comprising material composition may be alloyed iron. Especially, in embodiments, the iron matrix may comprise at least 50 wt. % iron, such as at least 60 wt. %, like at least 70 wt. %, especially at least 80 wt. %. Furthermore, in embodiments, the iron matrix may comprise (active) inclusions. The inclusions may, in embodiments, be compounds added to the iron matrix for example to provide stability, electrical conductivity, and micro-galvanic coupling. In embodiments, the iron comprising material composition may comprise inclusions selected from the range of 0.1-10 wt. %, such as from the range of 0.5-8 wt. %, like from the range of 1-4 wt. %, or such as from the range of 0.1-2 wt. %. The inclusions may especially, in embodiments, comprise one or more of: (i) a metal sulfide, (ii) a metal oxide, and (iii) a metal nitride. Herein, in embodiments, the metal of the metal sulfide/oxide/nitride may be selected from the group comprising: aluminum, manganese, copper, iron, cobalt, zinc, bismuth, lead, mercury, indium, gallium, and tin.

Hence, in embodiments, the iron comprising material composition comprises an iron matrix, wherein the iron matrix comprises at least 90 wt. % and 0.1-10 wt. % (active) inclusions, wherein the inclusions comprise one or more of CaAl₂O₄ selected from the range of 0.0001-0.01 wt. %, MnS selected from the range of 0.01-4 wt. %, Bi₂S₃ selected from the range of 0.1-8 wt. %, SiO₂ selected from the range of 0.01-2 wt. %, MnN selected from the range of 0.001-4 wt. %, CuS selected from the range of 0.001-5 wt. %, Bi₂O₃ selected from the range of 0.1-8 wt. %, FeS selected from the range of 0.001-10 wt. %, CoS selected from the range of 0.1-4 wt. %, ZnS selected from the range of 0.001-5 wt. %, CuO selected from the range of 0.001-5 wt. %, Al₂O₃ selected from the range of 0.001-2 wt. %, MnO selected from the range of 0.01-2 wt. %, MnO₂ selected from the range of 0.01-2 wt. %, CoO selected from the range of 0.001-5 wt. %, ZnO selected from the range of 0.001-5 wt. %, Si₃N₄ selected from the range of 0.01-2 wt. %, Zn₃N₂ selected from the range of 0.001-0.5 wt. %, Bi₃N selected from the range of 0.1-5 wt. %, Co₃N selected from the range of 0.001-2 wt. %.

Yet further, in embodiments, the invention provides the electrode as described above, wherein the iron comprising material composition may be provided as layer or body, such as especially as a layer, or such as especially as a body. Especially, in such embodiments, the layer or body may comprise a porosity (Φ). In embodiments, the porosity (Φ) of the layer or body may be selected from the range of 10-95 vol. %, such as from the range of 12-75 vol. %, like from the range of 15-65 vol. %, especially from the range of 25-50 vol. %.

The iron comprising material composition may, in embodiments, be obtainable by a method comprising thermal processing as described further below. In other embodiments, the iron comprising material composition may be obtainable by a method comprising mechanical or thermomechanical processing as (also) described further below.

In a yet further aspect, the invention provides a device comprising the electrode as described herein. Especially, in embodiments, the invention may provide a battery comprising the electrode as described herein. Hence, in such embodiments, the device may comprise a battery. For example, in embodiments, the device may comprise one of a nickel-iron battery, an alkaline battery, or a lithium-iron-phosphate battery. Generally, a battery may comprise one or more electrochemical cells. The one or more electrochemical cells may comprise electrodes, especially an anode and a cathode. In embodiments, the anode and the cathode may be configured electrically connected through an electrolyte. During discharging of the battery its positive electrode may be the cathode and its negative electrode may be the anode. As such, in embodiments, electrons may transfer from the anode to the cathode, and simultaneously metal ions may transfer from the anode through the electrolyte to the cathode. Especially, in embodiments, the electrolyte may comprise a (solid and/or liquid) medium comprising ions, which may diffuse freely throughout the medium. In embodiments, the device may thus comprise a battery comprising the electrode as described herein, such that the electrode is configured as the anode. In specific embodiments, the battery may comprise a metal-air battery. In such embodiments, the battery may thus consist of a metal anode and an external cathode in contact with ambient air.

In other embodiments, the invention may provide an electrolyser comprising the electrode as described herein. Hence, in such embodiments, the device may comprise an electrolyser. For example, in embodiments, the device may comprise one of an alkaline electrolysis cell, a proton electrolyte membrane (PEM) electrolysis cell, and a solid oxide electrolysis cell (SOEC). Generally, an electrolyser may comprise at least an anode and a cathode. In embodiments, during oxidation (the oxygen evolution reaction or OER) the anode may produce gaseous oxygen, and may release electrons into the surrounding solution. The electrons may then be used to power other chemical reactions, such as the formation of gaseous hydrogen (the hydrogen evolution reaction or HER) at the cathode. In embodiments, the device may thus comprise an electrolyser comprising the electrode as described herein, such that the electrode is configured as the anode.

Hence, in general, an electrode is an anode if it undergoes oxidation, which involves the loss of electrons. Thus as follows from the above, in embodiments, the electrode may especially be configured as anode (in the device).

In a yet further aspect, the invention provides a method for producing the iron comprising (electrode) material composition as described above. In embodiments, the method may comprise processing, especially one of thermal processing, mechanical processing, or thermomechanical processing of an iron comprising material to provide the iron comprising material composition. Herein, in embodiments, the iron comprising material may essentially be any material comprising iron. In embodiments, the iron comprising material may especially comprise at least 60% iron, such as at least 70% iron, especially at least 80% ion, like at least 90% iron, including 100% iron. In specific embodiments, the iron comprising material may comprise a sheet material, i.e., a sheet of iron. In such embodiments, the sheet material may be subjected to a preparatory phase prior to the first heating stage. Such a preparatory phase may, for example, comprise one or more of cutting, (ball-)milling, filtering, washing, sonicating, and drying the sheet material. Further, in embodiments, the iron comprising material may comprise a powder, i.e., an iron powder. In some embodiments, the iron powder may be alloyed. Yet further, in embodiments, the iron comprising material may comprise an iron ingot. Hence, in embodiments, the method for producing the iron comprising material composition may comprise one of thermal processing, mechanical processing, or thermomechanical processing of the iron comprising material to provide the iron comprising material composition. These different types of processing are described in further detail below.

In embodiments, the method may especially comprise thermal processing of an iron comprising material to provide the iron comprising (electrode) material composition. Especially, in embodiments, the method may comprise a first heating stage, a first holding stage, and a first quenching stage. The first heating stage may, in embodiments, comprise heating the iron comprising material to an annealing temperature (T_{A}) at a first heating rate. Especially, in embodiments, the first heating rate may be selected from the range of 0.5-30 °C/s. Further, the first holding stage may, in embodiments, comprise annealing or austenitizing the (heated) iron comprising material, such as especially annealing the (heated) iron comprising material, or such as especially austenitizing the (heated) iron comprising material. Especially, in embodiments, the first holding stage may comprise annealing or austenitizing the (heated) iron comprising material by maintaining the annealing temperature (T_{A}) for a first holding duration. More especially, in embodiments, the first holding duration may be selected from the range of 1 min.-48 hours. Yet further, in embodiments, the first quenching stage may comprise quenching the (annealed or austenitized) iron comprising material to room temperature at a first quenching rate using a gas. Especially, in embodiments, the first quenching rate may be selected from the range of 20-60 °C/s. Hence, in specific embodiments, the invention may provide a method for producing the iron comprising material composition as described herein, wherein the method comprises thermal processing of an iron comprising material to provide the iron comprising material composition, wherein the method comprises a first heating stage, a first holding stage, and a first quenching stage, wherein: (A) the first heating stage comprises heating the iron comprising material to an annealing temperature (T_{A}) at a first heating rate, wherein the first heating rate is selected from the range of 0.5-30 °C/s; (B) the first holding stage comprises annealing or austenitizing the iron comprising material by maintaining the annealing temperature (T_{A}) for a first holding duration, wherein the first holding duration is selected from the range of 1 min.-48 hours; (C) the first quenching stage comprises quenching the iron comprising material to room temperature at a first quenching rate using a gas, wherein the first quenching rate is selected from the range of 20-60 °C/s.

Such embodiments may be beneficial as the method may allow for tuning of the metallurgical features of the iron comprising material composition to the desired features using thermal treatments. Especially, the method may allow for the introduction of grains varying in metallurgical phases, grain diameter and crystallographic orientation. Hence, with the above-described method a plurality of (different) iron comprising material compositions may be obtained.

The first heating stage may, in embodiments, comprise heating the iron comprising material. The iron comprising material may especially be heated at a first heating rate. In embodiments, the first heating rate may be selected from the range of 0.5-150 °C/s, such as from the range of 25-100 °C/s, or such as from the range of 0.5-30 °C/s, like from the range of 5-30 °C/s. Especially, in embodiments, the iron comprising material may be heated at the first heating rate until an annealing temperature (T_{A}) may be reached.

Herein described heating steps may, in embodiments, be performed using one or more of a batch furnace, a box-type furnace, a car-type furnace, an elevator-type furnace, a bell-type furnace, a pit furnace, a salt bath furnace, a vacuum furnace, an electrical resistance furnace, a dilatometer, a muffle furnace, a tube furnace and a fluidized-bed furnace.

In embodiments, selection of the annealing temperature (T_{A}) may depend upon the desired resulting material features, such as the desired metallurgical phase(s). In embodiments, the annealing temperature may be at least 600 °C, such as at least 700 °C, like at least 800 °C, especially at least 900 °C. In specific embodiments, the annealing temperature (T_{A}) is selected from the range of 600-1300 °C. In such embodiments, ferrite-to-austenite and backward transformations in the iron comprising material may occur. In embodiments, holding at a higher temperature may facilitate higher grain growth rates, which may result in larger grain diameters than at a lower annealing temperature (T_{A}).

The (heated) iron comprising material may be annealed or austenitized during the first holding stage. The first holding stage may thus, in embodiments, subsequent the first heating stage. Especially, in embodiments, the first holding stage may comprise annealing or austenitizing the iron comprising material by maintaining the annealing temperature (T_{A}) for a first holding duration. In embodiments, the first holding duration may be selected from the range of 1 min.-48 hours, such as from the range of 5 min.-24 hours, like from the range of 30 min.-8 hours. Especially, in embodiments, the holding duration may be selected from the range of 5-90 min., such as from the range of 10-60 min., like from the range of 15-30 min. In embodiments, the first holding stage may especially be executed under a vacuum, i.e., the iron comprising material may be held at the annealing temperature (T_{A}) under vacuum.

The (annealed or austenitized) iron comprising material may be quenched during the first quenching stage. The first quenching stage may thus, in embodiments, subsequent the first heating stage. The first quenching stage may, in embodiments, comprise quenching the iron comprising material at a first quenching rate using a gas. In some embodiments, the iron comprising material may be quenched to an intermediate temperature, such as for example an intercritical annealing temperature (T_{1A}) or a sub-critical annealing temperature (T_{SA}), see also further below. In other embodiments, the iron comprising material may be quenched to room temperature, i.e., about 20 °C. In embodiments, the first quenching rate may especially be selected from the range of 10-150 °C/s, such as from the range of 25-100 °C/s, or such as from the range of 20-60 °C/s, like from the range of 25-50 °C/s.

As described above, in embodiments, during the first quenching stage a gas may be used to quench the iron comprising material to room temperature. With gas quenching the iron comprising material may be hardened and strengthened to obtain the iron comprising material composition. Such a gas may especially, in embodiments, comprise an inert gas, such as e.g. helium, argon, nitrogen, and hydrogen. Furthermore, in embodiments, the gas may (also) comprise a mixture of different types of gases, such as e.g. a mixture of nitrogen and argon. Hence, in embodiments, the gas comprises one or more of helium, argon, nitrogen, and hydrogen. Further, in embodiments, the gas may (also) comprise one or more of: a polymer, an oil, and water.

In embodiments, the (thermal processing) method may thus comprise (at least) a first heating stage, a first holding stage, and a first quenching stage. The method may further, in embodiments, comprise one or more additional stages. For example, in embodiments, the method may comprise a second quenching stage. Especially, in such embodiments, the second quenching stage may comprise quenching the iron comprising material to an intermediate temperature, e.g., an intercritical annealing temperature (T_{IA}) of the material. Further, such quenching may especially, in embodiments, occur at a second quenching rate. Especially, in embodiments, the second quenching rate may be selected from the range of 10-150 °C/s, such as from the range of 25-100 °C/s, or such as from the range of 20-60 °C/s, like from the range of 25-50 °C/s.

An intercritical temperature (T_{IA}) may especially be a temperature where a ferrous material may consist of a mixture of two phases, e.g., a mixture of ferrite and austenite. For low carbon ferrous materials the intercritical annealing temperature range (or “two-phase region”) may typically be between 700-820 °C. The specific intercritical annealing temperature (T_{IA}) within this range may depend on the composition of the ferrous material, i.e., the fraction of carbon and the presence of alloying elements such as manganese, nickel, and chromium. Low carbon materials typically have an intercritical annealing temperature in the lower part of this range, while high carbon materials have a higher intercritical annealing temperature. Further, for example, adding manganese or nickel may, in embodiments, lower the intercritical annealing temperature, while adding chromium may increase it.

Additionally or alternatively, in embodiments, the method may comprise a cooling stage. Especially, in such embodiments, the cooling stage may comprise cooling the iron comprising material to an intermediate temperature, e.g., a sub-critical annealing temperature (T_{SA}) of the material. Further, such colling may especially, in embodiments, occur at a cooling rate. Especially, in embodiments, the cooling rate may be selected from the range of 10-150 °C/s, such as from the range of 25-100 °C/s, or such as from the range of 20-60 °C/s, like from the range of 25-50 °C/s.

A sub-critical annealing temperature (T_{SA}) may refer to a temperature of a ferrous material below its intercritical annealing temperature (T_{IA}). In general, sub-critical annealing temperatures for ferrous materials may typically be in the range of 650-800 °C. The specific sub-critical annealing temperature (T_{SA}) within this range may depend on the composition of the ferrous material, i.e., the fraction of carbon and the presence of (non-metallic) alloying elements such as chromium, molybdenum, nickel, vanadium, sulfur, and phosphorus. As the carbon content increases, the sub-critical annealing temperature (T_{SA}) may also increase. Further, the type and amount of alloying elements present may either increase or decrease the sub-critical annealing temperature (T_{SA}). Yet further, higher levels of non-metallic elements may lower the sub-critical annealing temperature (T_{SA}).

Additionally or alternatively, in embodiments, the method may comprise a second (third, etc.) holding stage. Especially, in such embodiments, the second holding stage may comprise holding the iron comprising material at a constant temperature, i.e., isothermally, for a second holding duration. Especially, in embodiments, the second holding duration may be selected from the range of 1 min.-48 hours, such as from the range of 5 min.-24 hours, like from the range of 30 min.-8 hours. Especially, in embodiments, the second holding duration may be selected from the range of 5-90 min., such as from the range of 10-60 min., like from the range of 15-30 min. In embodiments, the second holding stage may especially be executed under a vacuum. For example, in embodiments, the second holding stage may comprise holding the iron comprising material at the intercritical annealing temperature (T_{IA}) of the material. In other embodiments, for example, the second holding stage may comprise holding the iron comprising material at a sub-critical annealing temperature (T_{SA}) of the material.

For example, in specific embodiments, an iron comprising material composition comprising ferrite and martensite metallurgical phases may be obtained by heating an iron comprising material to 1000 °C with a first heating rate of 10 °C/s, i.e., the first heating stage. In such embodiments, the heated iron comprising material may subsequently be austenitized at 1000 °C for a first holding duration of 30 minutes, i.e., the first holding stage. Further, in embodiments, the iron comprising material may be quenched to an intercritical annealing temperature (T_{IA}) of 740 °C at a first quenching rate of 30 °C/s, i.e., the first quenching stage. The iron comprising material may, in embodiments, be held at the intercritical annealing temperature (T_{IA}) for a second holding duration of 15 minutes, i.e., a second holding stage. Subsequently, in such embodiments, the iron comprising material may be quenched at a second quenching rate of 30 °C/s to room temperature, i.e., a second quenching stage, to obtain the iron comprising material composition comprising ferrite and martensite metallurgical phases.

In another example, in specific embodiments, an iron comprising material composition comprising ferrite and pearlite metallurgical phases may be obtained by heating an iron comprising material to 1000 °C with a first heating rate of 10 °C/s, i.e., the first heating stage. In such embodiments, the heated iron comprising material may subsequently be austenitized at 1000 °C for a first holding duration of 30 minutes, i.e., the first holding stage. Further, in embodiments, the iron comprising material may be quenched to an intercritical annealing temperature (T_{IA}) of 760 °C at a first quenching rate of 30 °C/s, i.e., the first quenching stage. The iron comprising material may, in embodiments, be held at the intercritical annealing temperature (T_{IA}) for a second holding duration of 15 minutes, i.e., a second holding stage. Subsequently, in such embodiments, the iron comprising material may be cooled to a sub-critical annealing temperature (T_{SA}) of 600 °C at a cooling rate of 30 °C/s, i.e., a cooling stage. The cooled iron comprising material may, in embodiments, be isothermally held at the sub-critical annealing temperature (T_{SA}) of 600 °C for a third holding duration of 2 hours, i.e., an isothermal holding stage. Subsequently, in such embodiments, the iron comprising material may be quenched at a second quenching rate of 30 °C/s to room temperature, i.e., a second quenching stage, to obtain the iron comprising material composition comprising ferrite and pearlite metallurgical phases.

Yet further, in embodiments, the (thermal processing) method may also comprise a(n additional) mechanical or thermomechanical process, such as cold rolling, hot rolling, forging, drawing, swaging, (equal channel angular) extrusion, high-pressure torsion, shot blasting and ball-milling the iron comprising material. Especially, in some embodiments, the method may comprise a combination of one or more of such (thermo)mechanical processes. Hence, in specific embodiments, the method further comprises one or more thermomechanical processes of the group comprising: cold rolling, hot rolling, forging, swaging, extrusion, and ball-milling the iron comprising material.

Such embodiments may be beneficial as (thermo)mechanical processes may provide additional means of tuning the metallurgical features of the iron comprising material composition, such as the number averaged equivalent circular grain diameter, the crystallographic orientation, and the dislocation density.

In embodiments, the method may thus comprise one or more (thermo)mechanical processes. Such a (thermo)mechanical process may, in embodiments, be applied prior to the first heating stage. In other embodiments, such a (thermo)mechanical process may be applied (at least partially) during the first heating stage, i.e., simultaneously. Further, in embodiments, such a (thermo)mechanical process may be applied after the first heating stage and prior to the first holding stage. In other embodiments, such a (thermo)mechanical process may be applied (at least partially) during the first holding stage, i.e., simultaneously. Yet further, in embodiments, such a (thermo)mechanical process may be applied after the first holding stage and prior to the first quenching stage. In other embodiments, such a (thermo)mechanical process may be applied (at least partially) during the first quenching stage, i.e., simultaneously. In yet other embodiments, such a (thermo)mechanical process may be applied after the first quenching stage. For example, in embodiments, the first quenching stage may be following by cold rolling of the (quenched) iron comprising material composition.

In embodiments, with (hot and/or cold) rolling processes the iron comprising material may be passed through a succession of rollers with increasingly narrow passages, such that the sample may be pressed into an increasingly thin layer (or ‘sheet’). In such embodiments, the iron comprising material composition may be tuned through optimization of one or more of the rolling speed and the degree of narrowing of the passages. Especially, in embodiments, the rolling speed may be selected from the range of 1.5-2500 mm/s, such as from the range of 3-1000 mm/s. Additionally or alternatively, in embodiments, with a forging process, the shape of the iron comprising material may be altered through repetitive hammering onto the iron comprising material. In such embodiments, the iron comprising material composition may be tuned through variation of a hammering force applied on the iron comprising material. Especially, in embodiments, the hammering force may be selected from the range of 10-500 MPa, such as from the range of 100-300 MPa. Additionally or alternatively, in embodiments, with a drawing process the iron comprising material may be drawn (or ‘pulled’), such that the material may stretch and thin out into a desired shape or thickness. In embodiments, a drawing process may comprise one of sheet drawing (i.e., plastic deformation over a curved axis), and bar drawing (i.e., drawing the material through a die in order to reduce its diameter and increase its length). In such embodiments, the iron comprising material composition may be tuned through optimization of one or more of a drawing speed, a drawing pressure, and the type of drawing. Especially, in embodiments, the drawing speed may be selected from the range of 0.1-10 m/s, such as from the range of 1-5 m/s. Further, in embodiments, the drawing pressure may be selected from the range of 50-500 MPa, such as from the range of 100-300 MPa. Additionally or alternatively, in embodiments, with a ball-milling process the iron comprising material may be ground in a ball-mill through repetitive impacting of balls on the material, thusly causing attrition of the material, as a result of a milling motion of the ball-mill. In such embodiments, the iron comprising material composition may be tuned through optimization of one or more of a ball-milling speed and a ball size. Especially, in embodiments, the ball-milling speed may be selected from the range of 50-900 RPM (rotations per minute), such as from the range of 100-400 RPM. Further, in embodiments, the ball size may be selected from the range of 100 μm to 20 mm, such as from the range of 500 μm to 10 mm.

In a yet further aspect, the invention provides a method for producing the iron comprising (electrode) material composition as described herein. In such an aspect, the method may especially comprise mechanical or thermomechanical processing of an iron comprising material to provide the iron comprising (electrode) material composition. Especially, in embodiments, the method may comprise one of: (i) mechanical processing comprising a mechanical manipulation stage, and (ii) thermomechanical processing comprising a material heating stage and a heated mechanical manipulation stage. The mechanical manipulation stage may, in embodiments, comprise one or more of the group comprising: rolling, forging, extrusion, swaging, drawing, and milling the iron comprising material to obtain the iron comprising material composition. Further, in embodiments, the material heating stage may comprise heating the iron comprising material to a first temperature (T1). Especially, in embodiments, the first temperature (T1) may be selected from the range of 100-1200 °C. Further, in such embodiments, the heated mechanical manipulation stage may comprise one or more of the group comprising: hot rolling, hot forging, hot deformation, hot extrusion, and hot drawing the heated iron comprising material to obtain the iron comprising material composition. In embodiments, the heated mechanical manipulation stage may be carried out at a temperature ranging from the first temperature (T1) up to 1200 °C. Hence, in specific embodiments, the invention may provide a method for producing the iron comprising material composition as described herein, wherein the method comprises mechanical or thermomechanical processing of an iron comprising material to provide the iron comprising material composition, wherein the method comprises one of: (A) mechanical processing comprising a mechanical manipulation stage, wherein the mechanical manipulation stage comprises one or more of the group comprising: rolling, forging, extrusion, swaging, drawing, and milling the iron comprising material; and (B) thermomechanical processing comprising a material heating stage and a heated mechanical manipulation stage, wherein the material heating stage comprises heating the iron comprising material to a first temperature (T1), wherein the first temperature (T1) is selected from the range of 100-1200 °C; and wherein the heated mechanical manipulation stage comprises one or more of the group comprising: hot rolling, hot forging, hot deformation, hot extrusion, and hot drawing the heated iron comprising material.

Such embodiments may be beneficial as the method may allow for tuning of the metallurgical features of the iron comprising material composition to the desired features using mechanical treatments. Especially, the method may allow for the introduction of grains varying in metallurgical phases, grain diameter and crystallographic orientation. Hence, with the above described method a plurality of (different) iron comprising material compositions may be obtained.

In embodiments, the method may thus comprise an essentially fully mechanical process, especially a mechanical process comprising a mechanical manipulation stage. In embodiments, the method may comprise a plurality of mechanical manipulation stages. The mechanical manipulation stage may, in embodiments, comprise one or more of the group comprising: rolling, forging, (equal channel angular) extrusion, swaging, drawing, and milling the iron comprising material. Especially, in embodiments, the mechanical manipulation stage may comprise a combination of one or more of rolling, forging, (equal channel angular) extrusion, swaging, drawing, and milling the iron comprising material. Further, in embodiments, the mechanical manipulation stage may comprise a temporal sequence of different steps selected from rolling, forging, (equal channel angular) extrusion, swaging, drawing, and milling the iron comprising material. Yet further, in embodiments, other mechanical manipulation processes may be possible as well, such as e.g. shot blasting or high-pressure torsion.

In embodiments, with extrusion the iron comprising material may be forced through a die using applied pressure, causing reshaping of the iron comprising material. In such embodiments the applied pressure may especially be selected from the range of 50-500 MPa, such as from the range of 100-300 MPa. Further, in embodiments, swaging may comprise an operation such as bending, cutting, punching and forming the iron comprising material while the iron comprising material is held in or on a swage block. Herein a swage block may refer to a block of cast iron or steel with a plurality of holes and/or indents of various different sizes and shapes. Yet further, in embodiments, with milling pieces of the iron comprising material may be cut away, i.e., removed, through the use of rotary cutters. In such embodiments, the (shape and structure of the) iron comprising material composition may be tuned through optimizing process conditions such as cutting direction, cutting speed, and cutting pressure. Especially, in embodiments, the cutting speed may be selected from the range of 50-200 m/min, such as from the range of 80-150 m/min. Further, in embodiments, the cutting pressure may be selected from the range of 5-50 MPa, such as from the range of 10-30 MPa.

Furthermore, in some embodiments, the mechanical manipulation stage may include one or more intermediate heat treatments to optimize the microstructural properties of (the iron matrix of) the iron comprising material composition.

In other embodiments, the method may comprise a thermomechanical process, especially a thermomechanical process comprising a material heating stage and a heated mechanical manipulation stage. In embodiments, the method may comprise a plurality of material heating stages and/or a plurality heated mechanical manipulation stages. The material heating stage may, in embodiments, precede the heated mechanical manipulation stage. However, in other embodiments, the material heating stage and the heated mechanical manipulation stage may occur (essentially) simultaneously. Further, in embodiments, one or more material heating stages and one or more heated mechanical manipulation stages may alternate in time.

The material heating stage may especially comprise heating the iron comprising material to a first temperature (T1). Especially, in embodiments, the first temperature (T1) may be selected from the range of 100-1200 °C, such as from the range of 300-1100 °C, like from the range of 500-1000 °C. The heated mechanical manipulation stage may, in embodiments, comprise one or more of the group comprising: rolling, forging, extrusion, or drawing the iron comprising material to obtain the iron comprising material composition. Especially, in embodiments, the heated mechanical manipulation stage may comprise a combination of rolling, forging, extrusion, or drawing the iron comprising material. Further, in embodiments, the heated mechanical manipulation stage may comprise a temporal sequence of different steps selected from the group comprising: rolling, forging, extrusion, or drawing the iron comprising material. Hence, in embodiments, the heated mechanical manipulation stage may be similar to the above-described mechanical manipulation stage, but here the material may be preheated to the first temperature (T1) and the following processes may be carried out at a temperature ranging from the first temperature (T1) to 1200 °C. Especially, in embodiments, the heated mechanical manipulation stage may be carried out at a temperature selected from the range of 500-1500 °C, such as from the range of 700-1200 °C.

In a yet further aspect, the invention may provide a method for producing an electrode. The method may especially, in embodiments, comprise (an iron comprising material composition preparation phase and) an electrode preparation phase. In embodiments, an iron comprising material composition preparation phase may comprise the method comprising thermal processing (as described above) to provide the iron comprising material composition. However, in other embodiments, the iron comprising material composition preparation phase may comprise the method comprising thermomechanical processing (as described above) to provide the iron comprising material composition. The electrode preparation phase may, in embodiments, comprise mixing starting materials to obtain a mixture. Especially, in embodiments, the starting materials may comprise 3-15 wt. % of a binding additive, 0-12 wt. % of a pore forming additive, and the balance of iron comprising material composition as described above. Further, in embodiments, the electrode preparation phase may comprise heating the mixture. Especially, the electrode preparation phase may comprise heating the mixture, such that the mixture may be malleable. Yet further, in embodiments, the electrode preparation phase may comprise pressing the heated mixture into pellets at a pressure selected from the range of 2-80 MPa. Yet further, in embodiment, the electrode preparation phase may comprise shaping the pellets to obtain the electrode with a porosity selected from the range of 10-95 vol. %. Hence, in specific embodiments, the invention may provide a method for producing an electrode, wherein the method comprises (an iron comprising material composition preparation phase and) an electrode preparation phase, wherein ((A) the iron comprising material composition preparation phase comprises the method as described herein to provide the iron comprising material composition; and (B)) the electrode preparation phase comprises (i) mixing starting materials to obtain a mixture, wherein the starting materials comprise 3-15 wt. % of a binding additive, 0-12 wt. % of a pore forming additive, and the balance of iron comprising material composition as described herein, (ii) heating the mixture, (iii) pressing the heated mixture into pellets at a pressure selected from the range of 2-80 MPa, and (iv) shaping the pellets to obtain the electrode with a porosity (Φ) selected from the range of 10-95 vol. %.

The iron comprising material composition preparation phase has been discussed in detail above. In embodiments, the electrode preparation phase may comprise mixing starting materials to obtain a mixture. Especially, the iron comprising material composition may, in embodiments, be combined with, especially mixed with, a binding additive and optionally a pore forming additive. Note, in embodiments, other starting materials may be added as well, see also further below. In embodiments, the resulting mixture may comprise (iron comprising material composition and) 1-18 wt. % binding additive, such as 3-15 wt. % binding additive, like 5-12 wt. % binding additive, especially 5-10 wt. % binding additive.

The binding additive may be mixed in with the iron comprising material composition, such that the iron comprising material composition may be formed into a desired hardened (electrode) structure or layer. In embodiments, the binding additive may be a polymeric additive. Especially, in embodiments, the binding additive may be selected from the group comprising polyethylene, carboxymethylcellulose, polytetrafluoroethylene, polyvinylidene fluoride, polyacrylate, polyvinylpyrrolidone, and polyethylene glycol. Further, in embodiments, the binding additive may comprise a combination of one or more different (polymeric) additives. Hence, in embodiments, the binding additive may comprise one or more of polyethylene, carboxymethylcellulose, polytetrafluoroethylene, polyvinylidene fluoride, polyacrylate, polyvinylpyrrolidone, and polyethylene glycol powder.

Further, in embodiments, the mixture may comprise (iron comprising material composition, binding additive, and) 0-15 wt. % pore forming additive, such as 0-12 wt. % pore forming additive, like 1-10 wt. % pore forming additive, especially 2-5 wt. % pore forming additive. For example, in embodiments, the starting materials may comprise (i) 4 wt. % binding additive, such as e.g. polyethylene, (ii) 2 wt. % pore forming additive, such as e.g., polystyrene (see also below), and (iii) the balance of iron comprising material composition, i.e., 94 wt. % iron comprising material composition.

The pore forming additive may especially, in embodiments, be selected from the group comprising potassium carbonate, calcium carbonate, and polystyrene. Further, in embodiments, the pore forming additive may comprise a combination of one or more different pore forming additives, such as one or more of potassium carbonate, calcium carbonate, and polystyrene. Hence, in embodiments, the pore forming additive may be selected from the group comprising one or more of potassium carbonate, calcium carbonate, and polystyrene.

In embodiments, the pore forming additive may enable the formation of pores in the electrode as the additive may be dispersed through the iron comprising material composition and may upon heating form/leave gas bubbles inside the heated mixture.

Yet further, in embodiments, the mixture may comprise at least 50 wt. % iron comprising material composition, such as at least 60 wt. %, especially at least 70 wt. %, like at least 80 wt. %.

Additionally or alternatively, in embodiments, the starting material may comprise carbon black. Hence, in embodiments, carbon black may be mixed in with the iron comprising material composition, the binding additive, and optionally the pore forming additive. Especially, in embodiments, the mixture may comprise at most 10 wt. % carbon black, such as at most 8 wt. % carbon black, like at most 5 wt. % carbon black, especially at most 3 wt. % carbon black, including at most 1 wt. % carbon black. Hence, in embodiments, the mixture may comprise at most 10 wt. % carbon black.

Such embodiments may be beneficial as the presence of (a relatively small amount of) carbon black in the electrode may provide improved electrical conductivity in the electrode.

The mixture may thus, in specific embodiments, comprise 3-15 wt. % binding additive, 0-12 wt. % pore forming additive, 0-10 wt. % carbon black and the balance of iron comprising material composition.

Further, in some embodiments, the starting material may comprise one or more additional metal sulfides, metal oxides, and metal nitrides, such as e.g. FeS, ZnS, Bi₂S₃ and Bi₂O₃. Such metal sulfides, metal oxides, and metal nitrides may further provide, during operation of the electrode, suppression of HER on the electrode. Especially, such embodiments may be beneficial as such additives may increase the overpotential of the HER, which may result in suppression of the HER by affecting the kinetics of HER during charging, and retarding iron anode passivation during discharging. Hence, in embodiments, addition of such metal sulfides, metal oxides, and metal nitrides to the mixture may provide improved efficiency of the electrode (resulting from the method).

The electrode preparation phase may further, in embodiments, comprise heating the mixture, such that the mixture may be malleable, i.e., such that the mixture may be shaped into any desired shape, such as e.g. a pellet, a block, or a disc. Therefore, in embodiments, the mixture may be heated to a liquefaction temperature. Especially, the liquefaction temperature may be selected from the range of 50-350 °C, such as from the range of 50-200 °C, like from the range of 100-150 °C. At such liquefaction temperature, the mixture may be suitable to press in any desired shape, such as a pellet. Hence, in embodiments, the electrode preparation phase may comprise pressing the heated mixture into pellets. In embodiments, pressing may occur at a pressure selected from the range of 1-100 MPa, such as from the range of 2-80 MPa, like from the range of 5-70 MPa, especially from the range of 20-60 MPa. By applying such a pressure, for example through the use of a uniaxial heated die press or a heated plate press, to the heated mixture, the mixture may form compact and firm pellets. The pellets may subsequently be subjected to milling or stamping such that a porosity of the compact pellets may be increased. Especially, the pellets may be shaped (such as e.g. milled or stamped) to obtain the electrode with a porosity (Φ). In embodiments, the porosity (Φ) may especially be selected from the range of 10-95 vol. %, such as from the range of 12-75 vol. %, like from the range of 15-65 vol. %, especially from the range of 25-50 vol. %.

In some embodiments, the pellet may be stamped to obtain a final design. Therefore, in embodiments, a final shape of the electrode may be designed using e.g. computer assisted drawing software. The design may then, in embodiments, be used to configure a machine press or a stamping press, such that the press may perform the required operations for obtaining the final shape of the electrode. For example, in embodiments, stamping (or pressing) may comprise an operation, such as e.g. punching, piercing, blanking, embossing, bending, flanging, hemming, and coining the pellet, to obtain the final shape (having the desired porosity).

In other embodiments, the pellet may be milled (see also further above) to obtain the final electrode (having the desired porosity). Therefore, in embodiments, mill sizes (of the rotary cutters) for milling the electrode may especially be selected from the range of 50 μm to 30 mm, such as from the range of 100 μm to 20 mm, like from the range of 200 μm to 5 mm, especially from the range of 500 μm to 2 mm. Hence, in embodiments, mill sizes for milling the pellets are selected from the range of 100 μm to 20 mm.

Such embodiments may be beneficial as the mill size may influence the porosity of the electrode. If the mill size is too large, the electrode may become too porous, which may cause the electrode to become more voluminous than desired. If the mill size is too small, the efficiency and selectivity of the electrode may decrease. Further, the mill size may be chosen specifically to provide optimized porous structures.

### BRIEF DESCRIPTION OF THE DRAWINGS

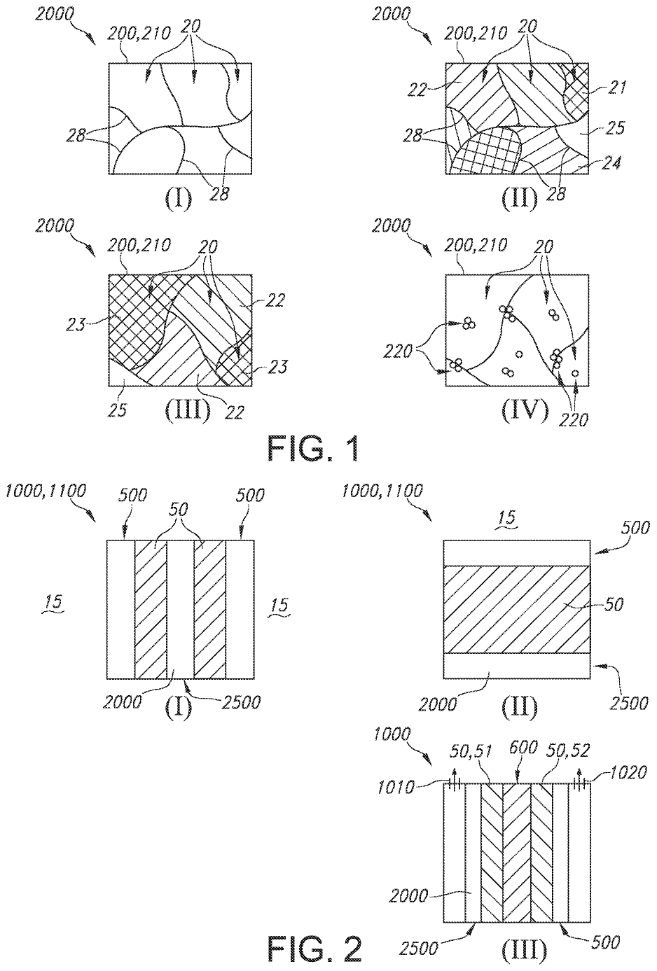

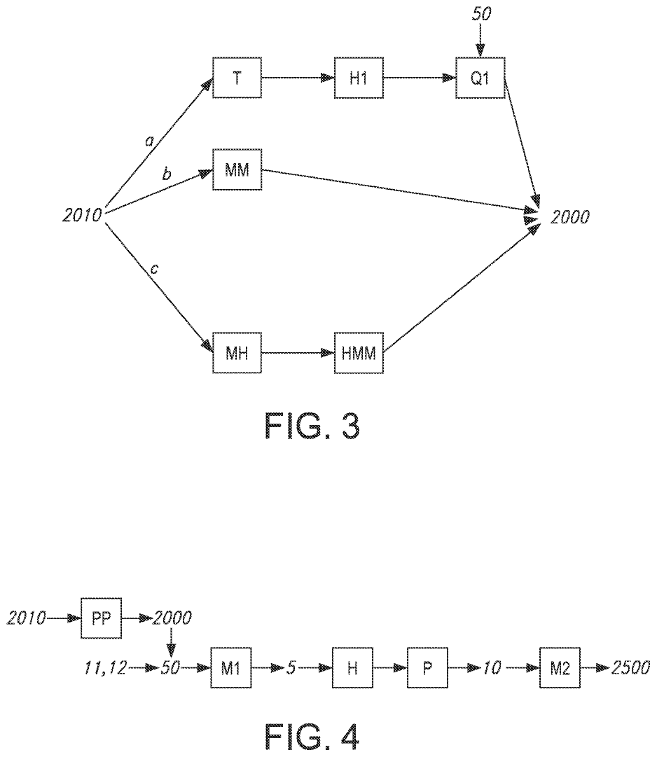

Embodiments of the invention will now be described, by way of example only, with reference to the accompanying schematic drawings in which corresponding reference symbols indicate corresponding parts, and in which: FIG. 1 schematically depicts some embodiments of the iron comprising material composition of the invention. FIG. 2 schematically depicts some embodiments of the device of the invention. FIG. 3 and FIG. 4 schematically depict embodiments of the methods of the invention. The schematic drawings are not necessarily on scale.

### DETAILED DESCRIPTION OF THE EMBODIMENTS

FIG. 1 schematically depicts the iron comprising material composition 2000 as described herein. Especially, in embodiments, the iron comprising material composition 2000 may comprise two or more metallurgical phases selected from the group consisting of: martensite, pearlite, bainite, and ferrite. Further, in embodiments, as depicted in FIG. 1 subfigure I, the iron comprising material composition 2000 may comprise grains 20. The grains 20 may especially have a number averaged equivalent circular grain diameter D, not depicted. In embodiments, the number averaged equivalent circular grain diameter D may be defined by grain boundaries 28. Further, in embodiments, the number averaged equivalent circular grain diameter D may be selected from the range of 1-100 μm. Yet further, in embodiments, the iron comprising material composition 2000 may comprise one or more of carbon, manganese, silicon, sulfur, aluminum, copper, bismuth, calcium, nitrogen, magnesium, zinc, cobalt, and tin. Especially, in embodiments, the iron comprising material composition 2000 may comprise carbon selected from the range of 0.022-4 wt. %. Especially, in embodiments, the iron comprising material composition 2000 may comprise manganese selected from the range of 0.1-4.2 wt. %. Especially, in embodiments, the iron comprising material composition 2000 may comprise silicon selected from the range of 0.01-4 wt. %. Especially, in embodiments, the iron comprising material composition 2000 may comprise sulfur selected from the range of 0.0001-12 wt. %. Especially, in embodiments, the iron comprising material composition 2000 may comprise aluminum selected from the range of 0.01-2 wt. %. Especially, in embodiments, the iron comprising material composition 2000 may comprise copper selected from the range of 0.01-2 wt. %. Especially, in embodiments, the iron comprising material composition 2000 may comprise bismuth selected from the range of 0.001-8.4 wt. %. Especially, in embodiments, the iron comprising material composition 2000 may comprise calcium selected from the range of 0.0001-0.4 wt. %. Especially, in embodiments, the iron comprising material composition 2000 may comprise nitrogen selected from the range of 0.0001-5 wt. %. Especially, in embodiments, the iron comprising material composition 2000 may comprise magnesium selected from the range of 0.0001-0.0004 wt. %. Especially, in embodiments, the iron comprising material composition 2000 may comprise tin selected from the range of 0.0001-0.5 wt. %. Hence, in embodiments, the iron comprising material composition 2000 may comprise one or more of the above mentioned elements with the balance of iron 210 and impurities.

Herein reference 200 may refer to an iron matrix, see also further below.

The iron comprising material composition 2000 may, in embodiments, comprise (i) 2-94.9 vol. % of one or more of martensite, pearlite, and bainite, and (ii) 5-70 vol. % ferrite, and 0.1-10 vol. % (retained) austenite. Especially, in embodiments, the iron comprising material composition 2000 may comprise at least 50 vol. % bainite.

Furthermore, in embodiments, at least 50 vol. % of the grains 20 may have a <110> crystallographic orientation.

In embodiments, as depicted in FIG. 1 subfigure II, for the iron comprising material composition 2000 may apply that at least part of a total number of the grains 20 may comprise martensite phase grains 21. Especially, in embodiments, the martensite phase grains 21 may have a number averaged equivalent circular grain diameter (Dₘ) selected from the range of 23-98 μm. Additionally or alternatively, as depicted in FIG. 1 subfigure II and III, for the iron comprising material composition 2000 may apply that at least part of a total number of the grains 20 may comprise bainite phase grains 22. Especially, in embodiments, the bainite phase grains 22 may have a number averaged equivalent circular grain diameter (D_{b}) selected from the range of 3-60 μm. Additionally or alternatively, as depicted in FIG. 1 subfigure III, for the iron comprising material composition 2000 may apply that at least part of a total number of the grains 20 may comprise pearlite phase grains 23. Especially, in embodiments, the pearlite phase grains 23 may have a number averaged equivalent circular grain diameter (Dₚ) selected from the range of 3-60 μm. Additionally or alternatively, as depicted in FIG. 1 subfigure II, for the iron comprising material composition 2000 may apply that at least part of a total number of the grains 20 may comprise ferrite phase grains 24. Especially, in embodiments, the ferrite phase grains 24 may have a number averaged equivalent circular grain diameter (D_{f}) selected from the range of 3-80 μm. As depicted in FIG. 1 subfigure II and III, the iron comprising material composition 2000 may in some embodiments comprise retained austenite phase grains 25.

Further, as depicted in FIG. 1 subfigure IV, the iron comprising material composition 2000 may comprise an iron matrix 200. Especially, in embodiments, the iron matrix 200 may comprise at least 90 wt. % iron 210 and 0.1-10 wt. % (active) inclusions 220. The inclusions may especially, in embodiments, comprise one or more of: (i) a metal sulfide, (ii) a metal oxide, and (iii) a metal nitride. Herein, in embodiments, the metal of the metal sulfide/oxide/nitride may be selected from the group comprising: aluminum, manganese, copper, iron, cobalt, zinc, bismuth, lead, mercury, indium, gallium, and tin. Especially, in embodiments, the inclusions 220 may comprise CaAl₂O₄ selected from the range of 0.0001-0.01 wt. %. Especially, in embodiments, the inclusions 220 may comprise MnS selected from the range of 0.01-4 wt. %. Especially, in embodiments, the inclusions 220 may comprise Bi₂S₃ selected from the range of 0.1-8 wt. %. Especially, in embodiments, the inclusions 220 may comprise SiO₂ selected from the range of 0.01-2 wt. %. Especially, in embodiments, the inclusions 220 may comprise MnN selected from the range of 0.001-4 wt. %. Especially, in embodiments, the inclusions 220 may comprise CuS selected from the range of 0.001-5 wt. %. Especially, in embodiments, the inclusions 220 may comprise Bi₂O₃ selected from the range of 0.1-8 wt. %. Especially, in embodiments, the inclusions 220 may comprise FeS selected from the range of 0.001-10 wt. %. Especially, in embodiments, the inclusions 220 may comprise CoS selected from the range of 0.1-4 wt. %, ZnS selected from the range of 0.001-5 wt. %. Especially, in embodiments, the inclusions 220 may comprise CuO selected from the range of 0.001-5 wt. %. Especially, in embodiments, the inclusions 220 may comprise Al₂O₃ selected from the range of 0.001-2 wt. %. Especially, in embodiments, the inclusions 220 may comprise MnO selected from the range of 0.01-2 wt. %. Especially, in embodiments, the inclusions 220 may comprise MnO₂ selected from the range of 0.01-2 wt. %. Especially, in embodiments, the inclusions 220 may comprise CoO selected from the range of 0.001-5 wt. %. Especially, in embodiments, the inclusions 220 may comprise ZnO selected from the range of 0.001-5 wt. %. Especially, in embodiments, the inclusions 220 may comprise Si₃N₄ selected from the range of 0.01-2 wt. %. Especially, in embodiments, the inclusions 220 may comprise Zn₃N₂ selected from the range of 0.001-0.5 wt. %. Especially, in embodiments, the inclusions 220 may comprise Bi₃N selected from the range of 0.1-5 wt. %. Especially, in embodiments, the inclusions 220 may comprise Co₃N selected from the range of 0.001-2 wt. %.

In embodiments, the inclusions may be configured interspersed with the iron 210. However, in some embodiments, at least 80% of the inclusions 220 may be configured (aggregated) at the grain boundaries 28. Furthermore, in embodiments, the inclusions 220 may be configured to provide one or more micro-galvanic coupling sites.

Furthermore, the iron comprising material composition 2000 may, in embodiments, be provided as layer or body. In such embodiments, the layer or body may especially comprise a porosity (Φ) selected from the range of 10-95 vol. %.

In another aspect, the invention may provide an electrode 2500 comprising the above described iron comprising material composition 2000. Especially, in embodiments, the electrode 2500 may comprise the iron comprising material composition 2000 comprising two or more metallurgical phases selected from the group consisting of: martensite, pearlite, bainite, and ferrite. Especially, in embodiments, the iron comprising material composition (of the electrode) may comprise (i) 2-97.9 vol. % of one or more of martensite, pearlite, and bainite, (ii) 2-85 vol. % ferrite, and (iii) 0.1-10 vol. % austenite. Further, in embodiments, iron comprising material composition 2000 may comprise grains 20. The grains 20 may especially have a number averaged equivalent circular grain diameter D. In embodiments, the number averaged equivalent circular grain diameter D may be defined by grain boundaries 28. Especially, in embodiments, the number averaged equivalent circular grain diameter D may be selected from the range of 1-100 μm.

Hence, the electrode 2500 may especially comprise the iron comprising material composition 2000. Embodiments, of the iron comprising material composition 2000, have been described in further detail above and may especially also apply to the iron comprising material composition 2000 comprised by the electrode 2500. In specific embodiments, the electrode 2500 may be an anode. Furthermore, in embodiments, the electrode 2500 may especially have a coulombic efficiency E_{C}≥95% calculated in a half cell.

As depicted in FIG. 2, in a further aspect, the invention may provide a device 1000 comprising the electrode 2500. Especially, as depicted in FIG. 2 subfigures I and II, the device 1000 may comprise a battery. Generally, in embodiments, the battery may comprise one or more electrochemical cells 1100. The one or more electrochemical cells 1100 may comprise electrodes, especially an anode, as depicted here the electrode 2500, and a cathode 500. In embodiments, the anode and the cathode may be configured electrically connected through an electrolyte 50. Especially, in embodiments, the electrolyte 50 may comprise a (solid and/or liquid) medium comprising ions, which may diffuse freely throughout the medium. As indicated by FIG. 2 subfigures I and II, in specific embodiments, the battery may comprise a metal-air battery. In such embodiments, the battery may thus consist of a metal anode 2500 and an external cathode 500 in contact with ambient air 15.

In other embodiments, such as depicted in FIG. 2 subfigure III, the device may comprise an electrolyser comprising the electrode 2500 as described herein. Generally, an electrolyser may comprise at least an anode, here the electrode 2500, and a cathode 500. Furthermore, as depicted, the electrolyser my comprise a membrane 600. In embodiments, during oxidation (the oxygen evolution reaction or OER) the anode may produce gaseous oxygen 1010, and may release electrons into the surrounding solution. The electrons may then be used to power other chemical reactions, such as the formation of gaseous hydrogen 1020 (the hydrogen evolution reaction or HER) at the cathode.

Especially, in embodiments, the electrode 2500 may thus be configured as anode (in the device 1000).

In a yet further aspect, the invention may provide a method for producing the iron comprising (electrode) material composition 2000 as described herein. The method may especially comprise thermal processing of an iron comprising material 2010 to provide the iron comprising (electrode) material composition 2000 (FIG. 3). The method is schematically depicted in FIG. 3 (route a) and may comprise a first heating stage T, a first holding stage H1, and a first quenching stage Q1. In embodiments, the first heating stage T may comprise heating the iron comprising material 2010 to an annealing temperature (T_{A}) at a first heating rate. Especially, in embodiments, the first heating rate may be selected from the range of 0.5-30 °C/s. Further, in embodiments, the first holding stage H1 may comprise annealing or austenitizing the iron comprising material 2010 by maintaining the annealing temperature (T_{A}) for a first holding duration. The first holding duration may, in embodiments, be selected from the range of 1 min-48 hours. Yet further, in embodiments, the first quenching stage Q1 may comprise quenching the iron comprising material 2010 to room temperature at a first quenching rate using a gas 50. Especially, in embodiments, the first quenching rate may be selected from the range of 20-60 °C/s.

Further, in embodiments, the annealing temperature (T_{A}) may be selected from the range of 600-1300 °C. Yet further, in embodiments, the gas 50 may comprise one or more of helium, argon, nitrogen and hydrogen.

Additionally, in embodiments, the method may further comprise one or more thermomechanical processes of the group comprising: cold rolling, hot rolling, forging, swaging, extrusion, and ball-milling the iron comprising material 2010.

Additionally or alternatively, as schematically depicted in FIG. 3 (route b, and c), in a yet further aspect, the invention may provide a method for producing the iron comprising (electrode) material composition 2000 as described herein. The method may especially comprise mechanical or thermomechanical processing of an iron comprising material 2010 to provide the iron comprising (electrode) material composition 2000. In embodiments, the method may comprise one of (i) mechanical processing comprising a mechanical manipulation stage MM as depicted in FIG. 3 route b, and (ii) thermomechanical processing comprising a material heating stage MH and a heated mechanical manipulation stage HMM as depicted in FIG. 3 route c.

Especially, in embodiments, the mechanical manipulation stage MM may comprise one or more of the group comprising: rolling, forging, extrusion, swaging, drawing, and milling the iron comprising material 2010.

In other embodiments, the material heating stage MH may comprise heating the iron comprising material 2010 to a first temperature (T1). Especially, in embodiments, the first temperature (T1) may be selected from the range of 100-1200 °C. Further, in such embodiments, the heated mechanical manipulation stage HMM may comprise one or more of the group comprising: hot rolling, hot forging, hot deformation, hot extrusion, and hot drawing the heated iron comprising material 2010.

In a yet further aspect, the invention may provide a method for producing an electrode 2500, as schematically depicted in FIG. 4. In embodiments, the method may comprise an iron comprising material composition preparation phase PP and an electrode preparation phase. The iron comprising material composition preparation phase PP may, in embodiments, comprise one of (i) the above described method to provide the iron comprising material composition 2000 comprising thermal processing (FIG. 3 route a), or (ii) the above described method to provide the iron comprising material composition 2000 comprising mechanical or thermomechanical processing (FIG. 3 routes b, and c, respectively). The electrode preparation phase may, in embodiments, comprise M1: mixing starting materials 50 to obtain a mixture. Especially, in embodiments, the starting materials 50 may comprise 3-15 wt. % of a binding additive 11, 0-12 wt. % of a pore forming additive 12, and the balance of the iron comprising material composition 2000 as described herein. The method may further, in embodiments, comprise H: heating the mixture 5. Yet further, in embodiments, the method may comprise P: pressing the heated mixture 5 into pellets 10 at a pressure selected from the range of 2-80 MPa. Yet further, in embodiments, the method may comprise M2: shaping the pellets 10 to obtain the electrode 2500 with a porosity selected from the range of 10-95 vol. %.

In specific embodiments, mill sizes (of the rotary cutters) for milling the pellets 10 may be selected from the range of 100 μm-20 mm.

Further, in embodiments, the binding additive may comprise one or more of polyethylene, carboxymethylcellulose, polytetrafluoroethylene, polyvinylidene fluoride, polyacrylate, polyvinylpyrrolidone, and polyethylene glycol powder.

Yet further, in some embodiments, the pore forming additive may comprise one or more of potassium carbonate, calcium carbonate, and polystyrene.

Additionally or alternatively, in embodiments, the mixture 5 may further comprise at most 10 wt. % of carbon black.

### Experiments

### Materials & Methods

Unless specified otherwise, the experiments described herein were performed according to the following procedures.

End product—Triple phase ferrous material (24 vol. % ferrite+73 vol. % bainite+3 vol. % retained austenite) having 28 μm grain diameter (D_{f}) for ferrite and 39 μm grain diameter (D_{b}) for bainite with 6-8 μm powder diameter and a porosity of 58%, leading to 97% of coulombic efficiency and more than 3500 cycles.

Preparation of the iron comprising material—The materials used were high-purity iron (Fe, 99.9%), bismuth (Bi, 99.99%), silicon (Si, 99.999%), carbon (C, 99.9%), nitrogen (N, 99.999%), and manganese (Mn, 99.9%). All materials were purchased from Sigma Aldrich and used without further purification. The ferrous material alloyed with iron, bismuth, silicon, carbon, nitrogen, and manganese was synthesized using powder metallurgy techniques. The powders of Fe, Bi, Si, C, N, and Mn were weighed in the desired proportions (see below) and mixed using a high-energy ball mill (Retsch MM400) for 8 hours to obtain a homogeneous mixture. The mixed powders were then compacted using a uniaxial press at 500 MPa to form a green compact with a diameter of 10 mm. The green compact was sintered in a vacuum furnace (Vacuum Atmospheres Company, VTA-1000) at a temperature of 1200 °C for 2 hours. The heating rate was 10 °C/min., and the cooling rate was 5 °C/min. The sintered sample was then annealed in a nitrogen atmosphere at 800 °C for 2 hours to reduce any oxide layers and improve the mechanical properties of the material.

The sheets of iron with a thickness of 2.2 mm were laser-cut to dimensions of 5×10 mm². The chemical composition of the samples was analyzed using wavelength dispersive spectrometry (WDS) with a JEOL JXA 8900R microprobe. An electron beam with an energy of 10 keV and beam current of 100 nA was used to measure the X-ray intensities of the constituent elements. To ensure accuracy, a background correction was conducted to the X-ray intensities relative to the corresponding intensities of reference materials at each measurement location. The resulting chemical composition of the samples was compared to the desired engineered composition during the alloying process and is presented in Table 1.

| | Fe | C | Bi | Mn | S | N |
|---|---|---|---|---|---|---|
| Wt. % | bal. | 0.42 | 0.24 | 1.46 | 0.01 | 0.006 |

Microstructure design—The Bahr DIL 805 A/D dilatometer was utilized to perform the heat treatment, with a heating rate of 10 °C s⁻¹ up to the austenization temperature of 1200 °C, followed by a 120-minute hold. Next, the samples were brought down to the intercritical annealing temperature of 740 °C at a rate of 30 °C s⁻¹ and kept for a first holding duration of 30 minutes. Then, they were cooled down at 30 °C s⁻¹ to reach an isothermal holding temperature of 600 °C and held for a second holding duration of 120 minutes before being quenched to room temperature using helium gas.

Material characterization—To analyze the microstructure of the samples following heat treatments, Electron Backscattered Diffraction (EBSD) measurements were performed. These measurements allowed for the extraction of crystallographic orientation, phases, geometrically necessary dislocation (GND) density, and grain size. To prepare the samples for EBSD measurements, they were ground using SiC papers ranging from 80 to 4000 grit and then polished to a mirror-like finish using diamond particle slurry (Struers DiaDuo-2) with particle sizes of 3 and 1 m. The final polishing was carried out using OP-S polishing. After polishing, the samples were cleaned in an ultrasonic bath using ethanol for 10 minutes and then dried with compressed air.

For EBSD measurements, a JEOL JSM 6500F FEG-SEM microscope with an EDAX/TSL detector was used. The step size and working distance for measurements were 1 and 17 μm, respectively, and the same step size was utilized in all measurements to avoid the impact on dislocation density calculations. The estimation of Geometrically Necessary Dislocations (GND) density was achieved through the use of OIM v7.3 software. This approach estimates the density of dislocations by connecting it with the Nye dislocation density tensor. This Nye tensor is determined by the tensorial addition of lattice curvature (or orientation curl) and the divergence of the elastic strain tensor. The collected data were analyzed using TSL-OIM v7.3 software and Matlab with MTEX routines. To ensure a sufficiently large statistical sample size for grain size, an area of 1.44 mm² per sample was investigated. After performing grain identification, the grain size was determined. In this process, a grain was identified as the volume enclosed by a closed loop, where all boundary segments have a misorientation angle larger than the lower threshold of 5°. Subsequently, the average grain diameter was determined by calculating the diameter of the equivalent circular area, which was equal to the average grain area. The grain size for bainite was conducted after a clean-up process.

Powder preparation—To prepare the heat-treated ferrous material for ball milling, it was first dried in a vacuum oven at 100 °C for 2 hours to eliminate any moisture. Once dried, the material was placed in a ball mill containing alumina balls. A mixture of ethanol solvent and polyvinylpyrrolidone (PVP) dispersant was added in a 1:10 weight ratio, and the ball mill was operated at a speed of 600 RPM for 3 hours to produce iron powder.

Following the milling process, the resulting iron powder was filtered through an 8-micron mesh sieve, washed with ethanol, and then subjected to 20 minutes of sonication in an ultrasonic bath to remove any remaining solvent. The powder was then dried in a vacuum oven at 100 °C for 2 hours and weighed on a balance to determine its mass.

Electrode preparation—The electrode was fabricated using 95% ferrous material powder and 5% polyethylene powder under heated press using a mold. The powder mixture was mixed at 200 RPM in a V-blender for 2 hours to obtain a homogenous powder mixture. Then, 144 gram of the powder mixture was weighed through analytical scale to obtain desired 4.5 mm thickness after pressing. The components were mixed together and heated to 140 °C in a vacuum furnace. Then, the heated powder mixture was added to the die press mold with the chamber dimensions of 8 cm×13 cm. The mold was pressed inside of heated chamber of uniaxial heated die press at 140 °C at a pressure of 60 MPa. The resulting pellets were milled through CNC milling (Haas TM-1P) with mill sizes ranging from 100 to 1200 μm to achieve optimized porous structures. The porous structures were debinded and sintered in a tube vacuum furnace (Carbolite Gero HTRH) under nitrogen and argon gases to remove the binder material. The debinding was performed 350 °C for 3 hours and followed by sintering at 850 °C for 1 hour. The porous structure with 62% was obtained after CNC milling and sintering.

Electrochemical testing—Electrochemical measurements including cyclic voltammetry and galvanostatic discharge were conducted in a polypropylene cell with three electrodes. The cell was designed to maintain a constant interelectrode distance of 0.7 mm, with the obtained electrode serving as the working electrode, platinum wire as the counter electrode, and Hg/HgO in 1 M NaOH as the reference electrode. An electrochemical workstation (Biologics VSP-300) was used to test the cell at room temperature in ambient air. The working electrode area was limited to 0.7 cm² by a viton O-ring. The electrolyte used was 6 M KOH (Sigma-Aldrich, reagent grade) obtained from ultrapure Millipore® water. The cyclic voltammograms were obtained by scanning the potential from −1.3 to 0.1 V at a rate of 0.5 mV s⁻¹, starting from the open circuit potential (OCP) around −1 V in the anodic direction. Prior to the CV measurement, the electrodes underwent cathodic polarization at −1.3 V for 5 minutes to eliminate the oxide layer from the surface of the iron electrode. Galvanostatic charge-discharge was conducted without any cut-off potentials at a current density of 50 mA cm⁻². The cyclic voltammetry showed the oxidation and reduction kinetics as well as hydrogen evolution reaction kinetics. It was observed that hydrogen evolution reaction kinetics were limited to 40 μA cm⁻² while the oxidation was significantly limited to Fe(OH)₂ formation, which shows the high reversibility of oxidation reduction reactions. This was also observed in the reversibility of oxidation and reduction reactions in CV. From galvanostatic charge discharge curves, coulombic efficiency of 97% was calculated still after 3500 cycles, which shows very limited capacity retention. Maximum discharge capacity of ~0.8 Ah/g (of iron) energy density was achieved. Herein, the maximum discharge capacity in Ah/g (of iron) may thus also be indicated as a maximum discharge capacity in Ah/g_{Fe}.

The term “plurality” refers to two or more. Furthermore, the terms “a plurality of” and “a number of” may be used interchangeably. The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. Moreover, the terms “about” and “approximately” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to.

The term “comprise” also includes embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

The term “further embodiment” and similar terms may refer to an embodiment comprising the features of the previously discussed embodiment, but may also refer to an alternative embodiment.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, “include”, “including”, “contain”, “containing” and the like are to be construed in an inclusive sense as opposed to an exclusive or exhaustive sense; that is to say, in the sense of “including, but not limited to”. The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings. Moreover, if a method or an embodiment of the method is described being executed in a device, apparatus, or system, it will be understood that the device, apparatus, or system is suitable for or configured for (executing) the method or the embodiment of the method, respectively.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. An electrode (2500) comprising an iron comprising material composition (2000), wherein the iron comprising material composition (2000) comprises two or more metallurgical phases selected from the group consisting of: martensite, pearlite, bainite, and ferrite, wherein the iron comprising material composition (2000) comprises (i) 2-97.9 vol. % of one or more of martensite, pearlite, and bainite, (ii) 2-85 vol. % ferrite, and (iii) 0.1-10 vol. % austenite; wherein the iron comprising material composition (2000) comprises one or more of:
carbon selected from the range of 0.022-4 wt. %;
manganese selected from the range of 0.1-4.2 wt. %;
silicon selected from the range of 0.01-4 wt. %;
sulfur selected from the range of 0.0001-12 wt. %;
aluminum selected from the range of 0.01-2 wt. %;
copper selected from the range of 0.01-2 wt. %;
bismuth selected from the range of 0.001-8.4 wt. %;
calcium selected from the range of 0.0001-0.4 wt. %;
nitrogen selected from the range of 0.0001-5 wt. %;
magnesium selected from the range of 0.0001-0.004 wt. %;
zinc selected from the range of 0.0001-5 wt. %;
cobalt selected form the range of 0.0001-5 wt. %; and
tin selected from the range of 0.0001-0.5 wt. %;
with the balance of iron (210) and impurities.

2. The electrode (2500) according to claim 1, wherein the iron comprising material composition (2000) comprises at least 50 vol. % bainite.

3. The electrode (2500) according to claim 1, wherein the iron comprising material composition (2000) comprises grains (20), wherein at least 50 vol. % of the grains (20) have a <110> crystallographic orientation; and wherein the iron comprising material composition (2000) comprises a dislocation density ρ_{d}, wherein ρ_{d}≥10¹² m⁻², wherein the dislocation density ρ_{d} is defined by the Nye dislocation density tensor.

4. The electrode (2500) according to claim 1, wherein the iron comprising material composition (2000) comprises grains (20), wherein the grains (20) have a number averaged equivalent circular grain diameter D, wherein the number averaged equivalent circular grain diameter D is defined by grain boundaries (28) and is derivable from a measurement using electron backscattered diffraction, wherein the number averaged equivalent circular grain diameter D is selected from the range of 1-100 μm.

5. The electrode (2500) according to claim 4, wherein one or more of the following applies:
at least part of a total number of the grains (20) comprise martensite phase grains (21), wherein the martensite phase grains (21) have a number averaged equivalent circular grain diameter Dₘ selected from the range of 23-98 μm;
at least part of a total number of the grains (20) comprise bainite phase grains (22), wherein the bainite phase grains (22) have a number averaged equivalent circular grain diameter D_{b} selected from the range of 3-60 μm;
at least part of a total number of the grains (20) comprise pearlite phase grains (23), wherein the pearlite phase grains (23) have a number averaged equivalent circular grain diameter Dₚ selected from the range of 3-60 μm; and
at least part of a total number of the grains (20) comprise ferrite phase grains (24), wherein the ferrite phase grains (24) have a number averaged equivalent circular grain diameter D_{f} selected from the range of 3-80 μm.

6. The electrode (2500) according to claim 5, wherein the iron comprising material composition (2000) comprises an iron matrix (200), wherein the iron matrix (200) comprises at least 90 wt. % iron (210) and 0.1-10 wt. % inclusions (220), wherein the inclusions (220) comprise one or more of CaAl₂O₄ selected from the range of 0.0001-0.01 wt. %, MnS selected from the range of 0.01-4 wt. %, Bi₂S₃ selected from the range of 0.1-8 wt. %, SiO₂ selected from the range of 0.01-2 wt. %, MnN selected from the range of 0.001-4 wt. %, CuS selected from the range of 0.001-5 wt. %, Bi₂O₃ selected from the range of 0.1-8 wt. %, FeS selected from the range of 0.001-10 wt. %, CoS selected from the range of 0.1-4 wt. %, ZnS selected from the range of 0.001-5 wt. %, CuO selected from the range of 0.001-5 wt. %, Al₂O₃ selected from the range of 0.001-2 wt. %, MnO selected from the range of 0.01-2 wt. %, MnO₂ selected from the range of 0.01-2 wt. %, CoO selected from the range of 0.001-5 wt. %, ZnO selected from the range of 0.001-5 wt. %, Si₃N₄ selected from the range of 0.01-2 wt. %, Zn₃N₂ selected from the range of 0.001-0.5 wt. %, Bi₃N selected from the range of 0.1-5 wt. %, or Co₃N selected from the range of 0.001-2 wt. %.

7. An iron comprising material composition (2000), wherein the iron comprising material composition (2000) comprises two or more metallurgical phases selected from the group consisting of: martensite, pearlite, bainite, and ferrite; wherein the iron comprising material composition (2000) comprises one or more of:
carbon selected from the range of 0.022-4 wt. %;
manganese selected from the range of 0.1-4.2 wt. %;
silicon selected from the range of 0.01-4 wt. %;
sulfur selected from the range of 0.0001-12 wt. %;
aluminum selected from the range of 0.01-2 wt. %;
copper selected from the range of 0.01-2 wt. %;
bismuth selected from the range of 0.001-8.4 wt. %;
calcium selected from the range of 0.0001-0.4 wt. %;
nitrogen selected from the range of 0.0001-5 wt. %;
magnesium selected from the range of 0.0001-0.004 wt. %;
zinc selected from the range of 0.0001-5 wt. %;
cobalt selected form the range of 0.0001-5 wt. %;
tin selected from the range of 0.0001-0.5 wt. %; and
with the balance of iron (210) and impurities.

8. The iron comprising material composition (2000) according to claim 7, wherein the iron comprising material composition (2000) comprises (i) 2-94.9 vol. % of one or more of martensite, pearlite, and bainite, (ii) 5-70 vol. % ferrite, and (iii) 0.1-10 vol. % austenite.

9. The iron comprising material composition (2000) according to claim 7, wherein the iron comprising material composition (2000) comprises at least 50 vol. % bainite.

10. The iron comprising material composition (2000) according to claim 7, wherein the iron comprising material composition (2000) comprises grains (20), wherein at least 50 vol. % of the grains (20) have a <110> crystallographic orientation; wherein the iron comprising material composition (2000) comprises a dislocation density ρ_{d}, wherein ρ_{d}≥10¹² m⁻², wherein the dislocation density ρ_{d} is defined by the Nye dislocation density tensor; and wherein the iron comprising material composition (2000) comprises an iron matrix (200), wherein the iron matrix (200) comprises at least 90 wt. % iron (210) and 0.1-10 wt. % inclusions (220), wherein the inclusions (220) comprise one or more of CaAl₂O₄ selected from the range of 0.0001-0.01 wt. %, MnS selected from the range of 0.01-4 wt. %, Bi₂S₃ selected from the range of 0.1-8 wt. %, SiO₂ selected from the range of 0.01-2 wt. %, MnN selected from the range of 0.001-4 wt. %, CuS selected from the range of 0.001-5 wt. %, Bi₂O₃ selected from the range of 0.1-8 wt. %, FeS selected from the range of 0.001-10 wt. %, CoS selected from the range of 0.1-4 wt. %, ZnS selected from the range of 0.001-5 wt. %, CuO selected from the range of 0.001-5 wt. %, Al₂O₃ selected from the range of 0.001-2 wt. %, MnO selected from the range of 0.01-2 wt. %, MnO₂ selected from the range of 0.01-2 wt. %, CoO selected from the range of 0.001-5 wt. %, ZnO selected from the range of 0.001-5 wt. %, Si₃N₄ selected from the range of 0.01-2 wt. %, Zn₃N₂ selected from the range of 0.001-0.5 wt. %, Bi₃N selected from the range of 0.1-5 wt. %, or Co₃N selected from the range of 0.001-2 wt. %.

11. The iron comprising material composition (2000) according to claim 7, wherein the iron comprising material composition (2000) comprises grains (20), wherein the grains (20) have a number averaged equivalent circular grain diameter D, wherein the number averaged equivalent circular grain diameter D is defined by grain boundaries (28) and is derivable from a measurement using electron backscattered diffraction, wherein the number averaged equivalent circular grain diameter D is selected from the range of 1-100 μm.

12. The iron comprising material composition (2000) according to claim 11, wherein one or more of the following applies:
at least part of a total number of the grains (20) comprise martensite phase grains (21), wherein the martensite phase grains (21) have a number averaged equivalent circular grain diameter Dₘ selected from the range of 23-98 μm;
at least part of a total number of the grains (20) comprise bainite phase grains (22), wherein the bainite phase grains (22) have a number averaged equivalent circular grain diameter D_{b} selected from the range of 3-60 μm;
at least part of a total number of the grains (20) comprise pearlite phase grains (23), wherein the pearlite phase grains (23) have a number averaged equivalent circular grain diameter Dₚ selected from the range of 3-60 μm; and
at least part of a total number of the grains (20) comprise ferrite phase grains (24), wherein the ferrite phase grains (24) have a number averaged equivalent circular grain diameter D_{f} selected from the range of 3-80 μm.

13. A device (1000) comprising the electrode (2500) according to claim 1.

14. The device (1000) according to claim 13, wherein the device (1000) further comprises one of a battery and an electrolyser.

15. The device (1000) according to claim 13, wherein the electrode (2500) is configured as anode.

16. A method for producing the iron comprising material composition (2000) according to claim 7, wherein the method comprises thermal processing of an iron comprising material (2010) to provide the iron comprising material composition (2000), wherein the method comprises a first heating stage, a first holding stage, and a first quenching stage, wherein:
the first heating stage comprises heating the iron comprising material (2010) to an annealing temperature (T_{A}) at a first heating rate, wherein the first heating rate is selected from the range of 0.5-30 °C/s;
the first holding stage comprises annealing or austenitizing the iron comprising material (2010) by maintaining the annealing temperature (T_{A}) for a first holding duration, wherein the first holding duration is selected from the range of 1 min.-48 hours; and
the first quenching stage comprises quenching the iron comprising material (2010) to room temperature at a first quenching rate using a gas (50), wherein the first quenching rate is selected from the range of 20-60 °C/s.

17. The method according to claim 16, wherein the annealing temperature (T_{A}) is selected from the range of 600-1300 °C; wherein the gas (50) comprises one or more of helium, argon, nitrogen and hydrogen; and wherein the method further comprises one or more thermomechanical processes of the group comprising: cold rolling, hot rolling, forging, swaging, extrusion, and ball-milling the iron comprising material (2010).

18. A method for producing the iron comprising material composition (2000) according to claim 7, wherein the method comprises mechanical or thermomechanical processing of an iron comprising material (2010) to provide the iron comprising material composition (2000), wherein the method comprises one of:
mechanical processing comprising a mechanical manipulation stage, wherein the mechanical manipulation stage comprises one or more of the group comprising: rolling, forging, extrusion, swaging, drawing, and milling the iron comprising material (2010); and
thermomechanical processing comprising a material heating stage and a heated mechanical manipulation stage, wherein the material heating stage comprises heating the iron comprising material (2010) to a first temperature (T1), wherein the first temperature (T1) is selected from the range of 100-1200 °C; and wherein the heated mechanical manipulation stage comprises one or more of the group comprising: hot rolling, hot forging, hot deformation, hot extrusion, and hot drawing the heated iron comprising material (2010).

19. A method for producing an electrode (2500) comprising an iron comprising material composition (2000), wherein the method comprises an electrode preparation phase, wherein the electrode preparation phase comprises (i) mixing starting materials (50) to obtain a mixture (5), wherein the starting materials (50) comprise 3-15 wt. % of a binding additive (11), 0-12 wt. % of a pore forming additive (12), and the iron comprising material composition (2000), (ii) heating the mixture (5), (iii) pressing the heated mixture (5) into pellets (10) at a pressure selected from the range of 2-80 MPa, and (iv) shaping the pellets (10) to obtain the electrode (2500) with a porosity selected from the range of 10-95 vol. %, wherein the iron comprising material composition (2000) comprises:
two or more metallurgical phases selected from the group consisting of: martensite, pearlite, bainite, and ferrite;
2-97.9 vol. % of one or more of martensite, pearlite, and bainite;
2-85 vol. % ferrite;
0.1-10 vol. % austenite; and
one or more of:
carbon selected from the range of 0.022-4 wt. %;
manganese selected from the range of 0.1-4.2 wt. %;
silicon selected from the range of 0.01-4 wt. %;
sulfur selected from the range of 0.0001-12 wt. %;
aluminum selected from the range of 0.01-2 wt. %;
copper selected from the range of 0.01-2 wt. %;
bismuth selected from the range of 0.001-8.4 wt. %;
calcium selected from the range of 0.0001-0.4 wt. %;
nitrogen selected from the range of 0.0001-5 wt. %;
magnesium selected from the range of 0.0001-0.004 wt. %;
zinc selected from the range of 0.0001-5 wt. %;
cobalt selected form the range of 0.0001-5 wt. %; and
tin selected from the range of 0.0001-0.5 wt. %;
with the balance of iron (210) and impurities.

20. The method according to claim 19, wherein the binding additive (11) comprises one or more of polyethylene, carboxymethylcellulose, polytetrafluoroethylene, polyvinylidene fluoride, polyacrylate, polyvinylpyrrolidone and polyethylene glycol powder; wherein the pore forming additive (12) comprises one or more of potassium carbonate, calcium carbonate, and polystyrene; and wherein the mixture (5) further comprises at most 10 wt. % of carbon black.
